(19) United States
(12) Patent Application Publication
(10) Pub. No.: US 2026/0290339 A1
(43) Pub. Date: Sep. 24, 2026

(54) SYSTEM

(71) Applicant: SoftBank Group Corp., Tokyo (JP)

(72) Inventor: Takaya AZUSAWA, Tokyo (JP)

(73) Assignee: SoftBank Group Corp., Tokyo (JP)

(21) Appl. No.: 19/564,390

(22) Filed: Mar. 12, 2026

(30) Foreign Application Priority Data
Mar. 19, 2025 (JP) 2025-044932

(51) Int. Cl. G10L 15/22; G06N 3/0499; G10L 13/00

(52) U.S. Cl. CPC G10L 15/22; G06N 3/0499; G10L 13/00

(57) ABSTRACT

A system includes a processor that is configured to: receive information from a user; input a prompt to a generative artificial intelligence model to instruct the generative artificial intelligence model to generate an appropriate response for analyzing the received information; and input text data to a speech synthesis algorithm to convert the generated response into audio data and to generate an audio signal.

### CROSS-REFERENCE TO RELATED APPLICATION

This application is based on and claims priority under 35 USC 119 from Japanese Patent Application No. 2025-044932 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional interactive systems that provide responses to user inputs typically rely on fixed rule-based logic or non-generative models. Such systems are limited in their ability to flexibly analyze diverse user information and to generate contextually appropriate responses. Furthermore, known systems that convert text to speech generally perform simple text-to-speech conversion without dynamically linking the content of a generative response to individualized or emotionally adaptive speech output. As a result, these systems do not sufficiently provide personalized entertainment experiences based on a user's past interactions, nor do they adequately support psychological stability by offering a place where a user can express and share emotions and thoughts while receiving responses that are tailored to the user's emotional state. There is therefore a need for a system that can (i) receive information from a user, (ii) utilize a generative artificial intelligence model to generate appropriate and personalized responses based on the user's information and interaction history, (iii) analyze emotional aspects of user input, and (iv) convert the generated responses into audio signals in a manner that improves user engagement and psychological support.

### SUMMARY

In order to solve at least the above-described problems, a system is provided which comprises a processor. The processor is configured to receive information from a user, input a prompt to a generative artificial intelligence model to instruct the generative artificial intelligence model to generate an appropriate response for analyzing the received information, and input text data corresponding to the generated response to a speech synthesis algorithm to convert the generated response into audio data and to generate an audio signal. The processor is further configured, based on the information from the user, to refer to past interaction data of the user and to adjust the prompt to the generative artificial intelligence model so as to instruct the generative artificial intelligence model to generate a personalized response, thereby providing a personalized entertainment experience to the user. Moreover, the processor is configured to provide a place for expressing and sharing emotions and thoughts of the user and to assist psychological stability by analyzing an emotion from input data of the user, and by reflecting a result of the analysis in the prompt to the generative artificial intelligence model to instruct the generative artificial intelligence model to generate a response corresponding to the emotion.

The term “system” refers to an arrangement of one or more hardware and/or software components that cooperate to perform the functions described in the claims, including but not limited to a server, a client device, a network, and associated storage or processing resources.

The term “processor” refers to any hardware device or combination of hardware devices capable of executing instructions, including but not limited to a central processing unit (CPU), a graphics processing unit (GPU), a digital signal processor (DSP), an application specific integrated circuit (ASIC), a field programmable gate array (FPGA), or a combination thereof, and may operate alone or in conjunction with memory and other components.

The term “user” refers to a human person who interacts with the system by providing information, including questions, requests, or personal thoughts, and who receives responses or audio outputs generated by the system.

The term “information from a user” refers to any data that is input by the user into the system, including but not limited to text, voice, images, or other forms of input that can be processed or interpreted by the system.

The term “prompt” refers to data or instructions input to the generative artificial intelligence model, which define, constrain, or guide the behavior of the generative artificial intelligence model in generating an appropriate response to the information from the user.

The term “generative artificial intelligence model” refers to a machine learning model configured to generate outputs such as text or other content in response to input data, including but not limited to large language models, transformer-based models, or other neural network models trained on large datasets.

The term “appropriate response” refers to a response generated by the generative artificial intelligence model that is relevant to, coherent with, and contextually suitable for the information received from the user, taking into account the content, intent, and context of the user's input.

The term “text data” refers to data representing characters, words, or sentences in a machine-readable form, which is suitable for processing by the speech synthesis algorithm to generate an audio output.

The term “speech synthesis algorithm” refers to software, hardware, or a combination thereof that converts text data into audio data representing speech, including but not limited to text-to-speech (TTS) engines and voice conversion algorithms.

The term “audio data” refers to digital data representing sound waves, including but not limited to sampled waveform data or compressed audio files, which can be converted into an audio signal for playback through a speaker or other audio output device.

The term “audio signal” refers to an electrical, analog, or digital signal representing sound, which can be supplied to a speaker, headphones, or other audio output devices for reproduction as audible sound.

The term “past interaction data” refers to data representing previous interactions between the user and the system, including but not limited to prior questions, responses, timestamps, user preferences, and behavioral history stored by the system.

The term “personalized response” refers to a response generated by the generative artificial intelligence model that is adjusted or tailored based on the past interaction data or other user-specific information, so as to better match the user's preferences, history, or characteristics.

The term “personalized entertainment experience” refers to an interaction experience provided to the user in which the content, style, or presentation of responses is customized based on user-specific data, thereby increasing engagement, enjoyment, and relevance for the individual user.

The term “emotion” refers to an affective state inferred from the user's input data, including but not limited to feelings such as happiness, sadness, loneliness, anxiety, anger, or calmness, which can be detected by analysis of linguistic content, tone, or other features.

The term “input data of the user” refers to any data provided by the user to the system that can be used for emotion analysis or response generation, including but not limited to textual input, spoken input, or other signals representing the user's expressions.

The term “analyzing an emotion from input data of the user” refers to processing the user's input data to estimate or classify an emotional state, using rule-based methods, machine learning methods, or combinations thereof, and to output a result indicating one or more emotions or emotional intensities.

The term “response corresponding to the emotion” refers to a response generated by the generative artificial intelligence model whose content, tone, or style is adapted based on the analyzed emotion, such that the response is empathetic, supportive, or otherwise appropriate to the user's emotional state.

The term “provide a place for expressing and sharing emotions and thoughts” refers to enabling the user to input and communicate personal feelings, concerns, or ideas to the system and to receive generated responses, such that the interaction functions as a communicative or supportive environment for the user.

The term “assist psychological stability” refers to supporting or improving the user's psychological well-being, for example by providing emotionally appropriate, empathetic, or comforting responses that may reduce stress, loneliness, or anxiety.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

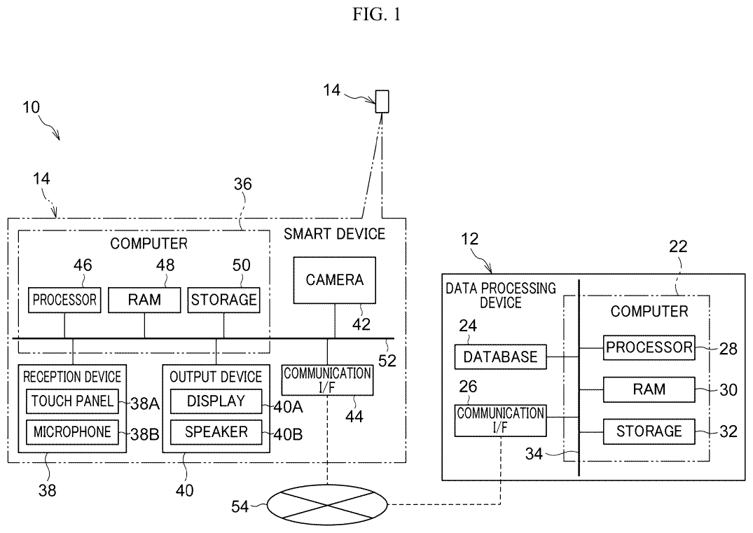

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

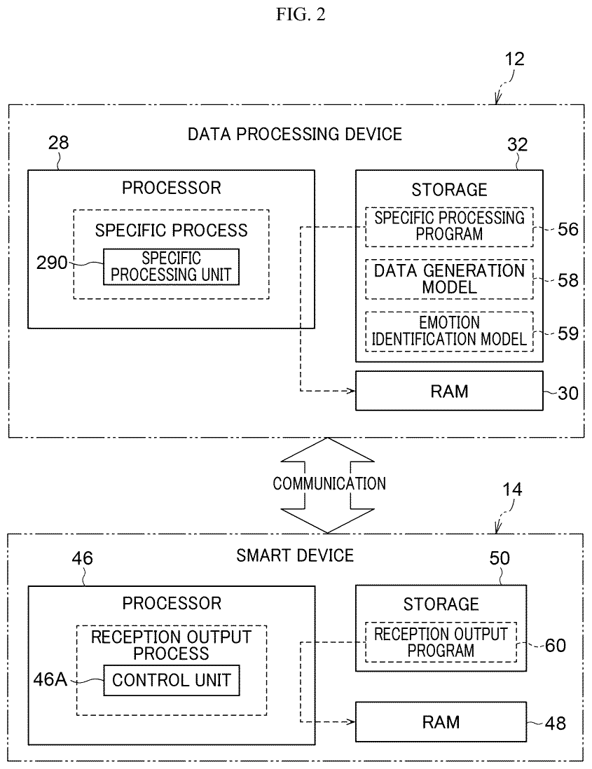

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional dialogue systems that utilize generative artificial intelligence models and text-to-speech processing often treat the language generation and the speech synthesis as loosely connected, independent components. In many existing implementations, a generic text response is first generated in isolation from user-specific context, and only thereafter is a standard voice model applied to read out the response. Such architectures have several technical drawbacks.

First, the processing pipeline tends to rely on ad hoc application logic for constructing inputs to the generative model, resulting in prompt sentences that are not systematically tailored to user context, conversation history, or emotional state. This can cause redundant or inconsistent prompts, increased token usage, and suboptimal model behavior, which in turn lead to higher computational load, increased latency, and unstable response quality.

Second, the coupling between the generated text and the downstream speech synthesis processing is often weak. Generated text is not explicitly shaped in a way that facilitates robust, efficient text-to-speech conversion. As a result, downstream TTS components may require additional normalization or correction, increasing processing overhead and error propagation, and sometimes causing mismatches between linguistic content and prosodic or stylistic characteristics in the synthesized audio.

Third, existing systems typically provide limited support for dynamically personalizing the generative model's behavior based on stored conversation history and user-specific preferences, including voice selection. When personalization is attempted, it is frequently implemented outside the core generation pipeline, for example through separate retrieval or rule-based modules, rather than through structured modification of the prompt sentence itself. This can create fragmented state management, inconsistent personalization across sessions, and inefficient reuse of historical data.

Fourth, most known systems lack an integrated mechanism to analyze the emotional state of the user from the input data and to encode the analysis result directly into the prompt sentence supplied to the generative AI model. Without such integration, emotional adaptation of responses is either absent or handled by downstream post-processing heuristics applied to already-generated text, which is technically less effective and can increase processing complexity without reliably improving the quality of the interaction.

Accordingly, there is a need for an improved computer-implemented architecture that provides a technically integrated pipeline from user input to audio output, in which (i) structured information derived from the user input, user identification, and conversation history is used to construct optimized prompt sentences for a generative AI model; (ii) personalization and emotional adaptation are performed at the prompt construction stage; and (iii) the resulting response text is post-processed into a format that is directly and efficiently consumable by a speech synthesis algorithm configured with user-selected voice identifiers. Such an architecture should improve system-level efficiency, latency, and robustness, while maintaining or improving the relevance and personalization of the generated audio responses.

The specific processing by the specific processing unit 290 of the data processing device 12 in Example 1 is realized by the following means.

The present invention provides a server comprising a processor configured to receive character-based user input and associated user identification information via a user-side apparatus, to generate structured information including the user input and the user identification information, to extract the user input from the structured information, to obtain conversation history information and, in some embodiments, emotional state information from a storage medium or analysis module, and to construct a prompt sentence on the basis of at least the user input and the conversation history information, the prompt sentence being formatted as an input sequence for a generative information processing model so as to guide generation of a response character string that is personalized and, where applicable, emotionally adapted; the processor being further configured to perform content checking and format adjustment on the response character string to generate a text string for speech synthesis processing, to associate the text string for speech synthesis processing with a voice identifier selected by the user, to cause a voice conversion processing apparatus to input the text string for speech synthesis processing into a speech synthesis algorithm using speaker feature information corresponding to the voice identifier so as to generate audio data, and to transmit the audio data in a communication format suitable for decoding and reproduction by the user-side apparatus. This enables an integrated, computer-implemented pipeline in which prompt sentence construction, generative AI model invocation, response post-processing, and voice-parameterized speech synthesis are coordinated within a unified server-controlled process, thereby reducing computational overhead and latency, improving robustness and consistency of generated responses, and providing technically enhanced personalization and emotional adaptation in the resulting audio output.

The term “system” refers to a combination of hardware and software components, including at least one processor, memory, communication interfaces, and peripheral devices, that cooperatively execute computer programs to perform the functions described in the claims.

The term “processor” refers to a hardware computation unit, such as a central processing unit or another instruction execution unit, configured to execute machine-readable instructions to perform logical, arithmetic, control, and input/output operations in accordance with the functionalities described in the claims.

The term “user-side apparatus” refers to an electronic device operated by a user, such as a handheld terminal, portable communication device, or computing terminal, that provides input and output interfaces for sending data to and receiving data from the server.

The term “character information” refers to digital data representing textual content, including letters, numerals, symbols, and other character-based elements, that is input by a user or generated by a system component.

The term “user identification information” refers to data that distinguishes one user from another, such as a user identifier, account identifier, session identifier, or other identification data that can be used to associate interactions with a specific user.

The term “structured information” refers to data organized in a predefined format, such as a record, message, or data object, that includes at least character information and user identification information, and that can be parsed and processed programmatically by a processor.

The term “communication interface” refers to hardware and software resources that enable data exchange between devices or components, including network interfaces, communication protocols, and associated control logic.

The term “storage medium” refers to a non-transitory computer-readable medium, such as semiconductor memory, magnetic storage, or optical storage, configured to store data and programs for retrieval and use by a processor.

The term “conversation history information” refers to data representing past interactions between the user and the system, including previous user inputs, system outputs, timestamps, and related contextual metadata.

The term “prompt sentence” refers to a text sequence constructed for input to a generative information processing model, the text sequence including at least user input, contextual information, and instruction information that guide the behavior of the generative information processing model.

The term “generative information processing model” refers to a machine-learned model, such as a generative artificial intelligence model, configured to process input data including a prompt sentence and to generate output data such as a response character string by performing probabilistic or neural-network-based computations.

The term “response character string” refers to a sequence of characters output by the generative information processing model in response to a prompt sentence, the sequence representing a textual answer or other generated content.

The term “content checking” refers to processing that examines a response character string to detect or correct undesired content, such as inappropriate language, policy-violating content, or format inconsistencies, in accordance with predetermined rules or criteria.

The term “format adjustment” refers to processing that modifies the structure, layout, or punctuation of a response character string to conform to predefined formatting requirements, such as sentence boundaries, whitespace normalization, or length constraints.

The term “text string for speech synthesis processing” refers to a version of a response character string that has undergone content checking and format adjustment and is prepared as input data for a speech synthesis algorithm.

The term “voice identifier” refers to data that specifies a particular voice profile, speaker identity, or set of voice characteristics to be used by a speech synthesis algorithm when generating audio data.

The term “voice conversion processing apparatus” refers to a hardware and software configuration, which may be local or remote, that executes speech synthesis or voice conversion algorithms to convert text input into audio data based on specified voice parameters.

The term “speech synthesis algorithm” refers to a computational procedure or model that converts text input into synthesized speech, including preprocessing, pronunciation generation, acoustic feature prediction, and waveform generation processes.

The term “speaker feature information” refers to data representing characteristics of a target voice, such as timbre, pitch range, prosody, or other speaker-dependent attributes, used by a speech synthesis algorithm to produce audio in a specified voice style.

The term “audio data” refers to digital data representing sound, including sampled waveform data, encoded streams, or other representations that can be decoded and reproduced as audible signals.

The term “communication format” refers to an encoding or packaging scheme for audio data or other data, including file formats, streaming formats, and protocol-specific representations, that is suitable for transmission over a communication interface.

The term “acoustic output apparatus” refers to a hardware device configured to convert digital audio data into audible sound, such as a loudspeaker, earphone, or headset.

The term “personalized response” refers to a response character string whose content or style is adapted based on user-specific information, such as conversation history information, user preferences, or user identification information.

The term “emotion analysis processing” refers to computational processing applied to input data, such as character information, to estimate an emotional state of a user by using rule-based methods, statistical models, or machine-learned models.

The term “emotional state” refers to an estimated psychological or affective condition of a user, such as happiness, sadness, anxiety, or calmness, inferred from user input or interaction patterns.

The term “instruction information” refers to textual or symbolic data included in a prompt sentence that specifies constraints or guidelines for the generative information processing model, such as desired tone, style, length, or content restrictions.

The term “response style” refers to characteristics of a generated response, including tone, formality level, degree of detail, or narrative structure, as indicated by instruction information or other control data.

The term “expression policy” refers to a set of rules or guidelines governing how information is expressed in a response, including limitations on certain types of statements, required disclaimers, or preferences for certain phrasings.

In one embodiment, a server cooperates with at least one terminal operated by a user to implement the claimed system. The server comprises at least one processor, a main memory, a non-volatile storage device, and a network interface, and is connected via a communication network such as the Internet to the terminal. The terminal comprises a processor, a memory, a display device, an input device such as a touchscreen, and an acoustic output apparatus such as a loudspeaker or headphone interface.

The server executes application software implemented, for example, using a server-side framework such as a generic web application framework running on an operating system. The server further executes a generative AI model implemented as a trained neural network, and a text processing module, a prompt sentence construction module, a conversation history management module, an emotion analysis module, and a text-to-speech (TTS) control module. The terminal executes client software implemented, for example, as a mobile application or web browser application, and provides a user interface for text input and audio output.

The terminal accepts character information from the user through a text input field rendered on the display. The terminal converts the typed characters into encoded text data (e.g., UTF-8) and associates the text data with user identification information stored locally, such as a user ID or session ID. The terminal generates structured information, for example in the form of a record containing fields for user text, user identification information, and optional parameters such as a selected voice identifier and a language setting. The terminal transmits this structured information to the server via the network interface using a communication protocol such as HTTPS over TCP/IP.

The server receives the structured information through the network interface and passes it to the processor. The server parses the structured information to extract the user text, user identification information, voice identifier, and any other metadata. The server normalizes the user text by performing character normalization and removal of control characters using text processing routines. The server stores the normalized user text and associated metadata in a storage medium, such as a database, as conversation history information, thereby enabling subsequent retrieval and context continuation.

The server constructs a prompt sentence for a generative AI model by combining multiple components in memory. The server retrieves conversation history information associated with the same user identification information or conversation identifier. The server formats the conversation history information as a sequence of text segments labeled as user and assistant turns. The server concatenates a role description, constraint instructions, the formatted conversation history, and the current user text into a single prompt sentence. For example, the server may construct a prompt sentence such as:

“You are a helpful assistant. Answer the user's question in clear and concise English.

### Previous Dialog:

User: What will the weather be like today in Tokyo?
Assistant: Today in Tokyo, it will be mostly sunny with mild temperatures.

### New User Question:

What about tomorrow's weather in Osaka?
Assistant:”

In another example, the server may construct a prompt sentence emphasizing emotional support, such as:
“You are a supportive companion. The user is feeling anxious. Respond in a calm and empathetic tone. Avoid giving medical or legal advice. Keep the answer under 150 words.
User: I feel very nervous recently. What should I do?
Assistant:”

The server uses a prompt sentence construction module that applies explicit rules for ordering and delimiting text segments. The module ensures that the instruction portion, context portion, and question portion are separated by line breaks and markers such as “User:” and “Assistant:”. This structured formatting improves the generative AI model's ability to interpret the input consistently, thereby reducing the need for repeated clarifications and lowering token usage. As a result, the server reduces computational load and improves response time.

The server executes the generative AI model on a computing substrate that may include one or more accelerators such as graphics processing units. The generative AI model is implemented, for example, as a transformer-based neural network having multiple layers of self-attention mechanisms and feed-forward networks. The server represents the prompt sentence as a sequence of token identifiers by using a tokenizer associated with the model. The tokenizer converts character sequences into subword units based on a learned vocabulary, thereby enabling efficient processing of diverse languages and character sets. The server inputs the token sequence into the generative AI model. Within the model, the processor executes a forward pass in which input tokens are embedded into continuous vectors, combined with positional encodings, and processed through multiple transformer blocks. Each transformer block computes self-attention weights over all token positions, multiplies these weights with value vectors, and passes the result through normalization and non-linear activation functions. The server configures model parameters such as the number of layers, the hidden dimensionality, and the number of attention heads based on available computing resources and desired performance.

The server uses a decoding algorithm, such as greedy decoding or sampling with temperature and top-k or nucleus sampling, to generate an output token sequence representing a response character string. The server configures decoding parameters (for example, temperature, maximum token length, and stop conditions) as part of the instruction to the generative AI model. By carefully tuning these parameters, the server preserves coherence while limiting excessive verbosity, thereby improving both computational efficiency and user experience.

The server performs content checking and format adjustment on the generated response character string. The server executes a content checking module that applies pattern matching and rule-based filters to detect prohibited expressions, irrelevant content, or malformed segments. The server may, for example, reject responses containing specific keywords or patterns and request regeneration with modified decoding parameters. The server also adjusts the format of the response by normalizing whitespace, ensuring proper sentence termination, and adding or removing line breaks according to a predefined style. The result is a text string for speech synthesis processing, which is optimized for downstream TTS algorithms.

The server associates the text string for speech synthesis processing with a voice identifier selected by the user. The server maintains a mapping table in the storage medium that associates voice identifiers with corresponding speaker feature information used by a TTS engine. Speaker feature information may include an embedding vector representing speaker timbre, pitch range, and prosody, derived during a prior training phase of the TTS model.

The server causes a voice conversion processing apparatus to generate audio data based on the text string and the speaker feature information. In one embodiment, the voice conversion processing apparatus is implemented as a local TTS engine running on a processor and an accelerator. In another embodiment, the voice conversion processing apparatus is implemented as a remote TTS service accessed via a network interface. In either case, the TTS engine includes a text preprocessing front-end, an acoustic model, and a vocoder model. The server inputs the text string for speech synthesis processing into the text preprocessing front-end of the TTS engine. The front-end converts character sequences into phoneme sequences, performs text normalization such as expansion of abbreviations, and computes linguistic features such as part-of-speech tags and syllable boundaries. The server then causes the acoustic model to convert the linguistic features and speaker feature information into acoustic feature sequences, such as mel-spectrograms. The acoustic model may be implemented as a sequence-to-sequence neural network, such as a recurrent neural network or transformer, trained with parallel text-audio pairs. The server further causes the vocoder model, such as a generative adversarial network-based vocoder, to convert the acoustic feature sequences into waveform samples representing audio data.

The server converts the generated audio data into a communication format suitable for transmission to the terminal. The server may, for example, encode linear PCM waveform data into a compressed audio format, such as a perceptual audio codec, using a media processing library. The server packages the encoded audio data with metadata including sampling rate, channel count, and duration, and transmits it to the terminal over the network interface.

The terminal receives the audio data and decodes it using an audio codec supported by the operating system's multimedia framework. The terminal converts the compressed audio into PCM samples and outputs the samples to the acoustic output apparatus. The user listens to the synthesized voice corresponding to the response character string. Because the server has generated response text that is structurally adapted for TTS and has selected an appropriate voice profile, the user perceives an intelligible and personalized audio response with stable prosody and reduced artifacts.

In another embodiment, the server executes an emotion analysis module before constructing the prompt sentence. The server analyzes the user text to estimate an emotional state by extracting features such as word choice, punctuation patterns, and sentence structure, and by inputting these features into a trained emotion classification model. The emotion classification model may be implemented as a neural network trained with labeled text examples representing various emotional states. The server encodes the estimated emotional state as instruction information appended to the prompt sentence, for example:

“The user appears to be anxious. Respond in a calm, reassuring tone, avoid technical jargon, and keep the answer under 120 words.”

This explicit encoding enables the generative AI model to adapt its response style without relying on implicit inference. As a result, the server reduces the need for post-hoc style corrections and minimizes re-generation attempts, thereby improving processing efficiency and latency.

The server also uses conversation history information to adjust the level of detail in the response. When the conversation history indicates that the user has already received an overview of a topic, the server modifies the prompt sentence to request additional depth or clarification instead of repeating basic explanations. This modification is implemented by inserting context-specific instructions into the prompt sentence, such as:

“The user has already received a basic explanation of this topic. Provide a more detailed, step-by-step explanation, focusing on new information and avoiding repetition.”

By embedding such instructions at the prompt construction stage, the server improves the generative AI model's ability to produce contextually appropriate responses, which reduces redundant output and the bandwidth required for transmitting unnecessary audio data.

From a technical standpoint, this architecture improves computer technology in several ways. The server structures input data into explicit prompt sentences that encode user state, context, and control instructions, thereby transforming unstructured user text into a machine-optimized representation. This structured prompt construction reduces ambiguity faced by the generative AI model, resulting in fewer incorrect or off-topic responses and less need for regeneration. Consequently, the server reduces the number of forward passes through the neural network, improving processing speed and reducing energy consumption.

The server's integration of conversation history and emotion analysis into prompt construction also enhances data management within the system. By storing conversation turns in an indexed format and retrieving them selectively for inclusion in prompt sentences, the server prevents uncontrolled context growth and associated memory usage. The server can, for example, limit history retrieval to the most recent or thematically relevant turns using explicit rules, thereby improving computational efficiency without sacrificing contextual relevance.

The server's generation of TTS-optimized text strings provides a further technical improvement. The server explicitly formats line breaks, punctuation, and numerical expressions in a way that reduces mispronunciations and unnatural prosody in the TTS engine. This reduces the need for the TTS engine to perform complex normalization heuristics and contributes to more predictable, lower-latency audio generation. Because the text is already prepared for speech, the TTS engine can operate with simplified preprocessing, which improves overall system throughput.

The server employs a non-conventional combination of neural architectures and processing rules. Instead of merely passing raw user text to a generative AI model and then reading the result with a generic TTS engine, the server enforces a multi-stage, rule-driven transformation: structured encoding of interaction data, context- and emotion-aware prompt sentence construction, controlled parameterization of decoding, and voice-specific audio synthesis. These processing steps are not simply human tasks executed faster, but rather are algorithmic transformations specifically designed to exploit the properties of neural models and audio codecs in ways that cannot practically be performed by a human operator.

In alternative embodiments, the server may employ different generative AI model architectures, such as encoder-decoder transformers, recurrent networks, or mixture-of-experts models, and different TTS models, such as autoregressive or flow-based vocoders. The server may also vary the structure of the prompt sentence depending on the application domain, for example, news summarization, educational explanations, or interactive entertainment. In some variants, the server may dynamically choose among multiple generative AI models or TTS engines based on system load, latency constraints, or language detection, while keeping the overall data flow and prompt construction principles unchanged. By implementing these embodiments, the server, the terminal, and the user cooperate in a system that provides technically enhanced generation, management, and delivery of personalized audio responses. The specific structuring of prompt sentences, the controlled interaction with a generative AI model, and the optimization of text for speech synthesis collectively yield improvements in processing speed, accuracy, and resource utilization within the computing environment.

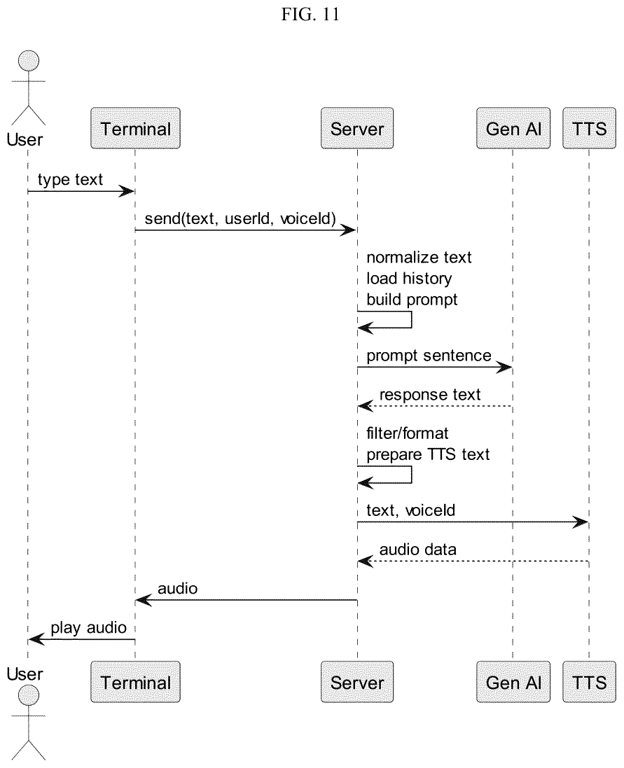

The following describes the processing flow using FIG. 11.

### Step 1:

The user operates the terminal and inputs character information such as a question or request into a text input field displayed on the screen. The input is, for example, a sentence like “What will the weather be like tomorrow in Tokyo?” or “I feel nervous recently, what should I do?”.

The terminal receives the typed characters as key events from the touchscreen keyboard, converts the sequence of key events into a text string encoded in a character set such as UTF-8, and displays the text string in the input field.

The input of this step is the user's keystrokes and touch interactions; the output is a structured in-memory representation of the user text string within the terminal's application.

### Step 2:

The terminal associates the user text string with user identification information and optional parameters, such as a voice identifier and a language setting, which are stored in the terminal's local storage or session state.

The terminal generates structured information, for example a record containing fields “user_text”, “user_id”, “voice_id”, and “language”, by assembling these values into a data structure.

The terminal sends this structured information as a request message to the server via a communication protocol such as HTTPS over TCP/IP.

The input of this step is the user text string and locally stored user-related parameters; the output is a serialized request message transmitted to the server.

### Step 3:

The server receives the request message via a network interface and forwards it to an application process.

The server parses the serialized request to reconstruct the structured information, extracting the values of “user_text”, “user_id”, “voice_id”, and “language”.

The server performs normalization on the user_text, such as trimming whitespace, converting incompatible character encodings, and removing control characters, by applying text processing functions.

The input of this step is the serialized request message from the terminal; the output is a normalized text string and associated metadata stored in server memory.

### Step 4:

The server stores the normalized user text and associated metadata as a new entry in conversation history information in a storage medium, such as a database table or key-value store.

The server retrieves one or more previous conversation turns associated with the same user_id or a conversation identifier, using database queries that select recent records and order them by timestamp.

The server constructs a context representation by concatenating previous user and assistant turns with markers such as “User:” and “Assistant:”, forming a chronological text history.

The input of this step is the normalized user text and user identification information; the output is a context text block representing the conversation history.

### Step 5:

The server analyzes the current user text to estimate an emotional state by extracting features such as word frequency, punctuation usage, and sentence length, and inputting these features into an emotion classification model stored in memory.

The server executes the emotion classification model (for example, a neural network or statistical classifier) to compute a probability distribution over predefined emotional categories, and selects the category with the highest probability as the estimated emotional state.

The server encodes the estimated emotional state as a short instruction phrase, such as “The user appears anxious; respond in a calm and reassuring tone.”

The input of this step is the normalized user text; the output is an instruction phrase describing the emotional state and desired response style.

### Step 6:

The server constructs a prompt sentence for a generative AI model by combining several components: a role description, system-level instructions, the context text block from the conversation history, the current user text, and the emotional-state instruction phrase.

The server concatenates these components in a predefined order, separated by line breaks and labels, for example:

“You are a helpful assistant. Answer the user's question in clear English.

The user appears anxious; respond in a calm and reassuring tone.

### Previous Dialog:

User: [previous question]
Assistant: [previous answer]

### New User Question:

[normalized user text]
Assistant:”

The server stores this constructed text as a prompt sentence in memory, associated with the current request.

The input of this step is the context text block, the normalized user text, and the emotional-state instruction phrase; the output is a single prompt sentence string ready for model input.

### Step 7:

The server converts the prompt sentence into a sequence of token identifiers using a tokenizer associated with the generative AI model. The tokenizer segments the text into subword units and maps each unit to an integer ID based on a vocabulary table.

The server configures model input parameters such as maximum token length, temperature, and top-k or top-p sampling thresholds, forming a model input structure that contains the token sequence and decoding settings.

The server calls the generative AI model, which is implemented as a neural network (for example, a transformer with multiple layers of self-attention and feed-forward blocks), and passes the model input structure to the model running on a processor and, optionally, on an accelerator.

The input of this step is the prompt sentence text; the output is an internal model input representation consisting of token IDs and configuration parameters supplied to the generative AI model.

### Step 8:

The server causes the generative AI model to perform a forward pass over the token sequence. Inside the model, the processor computes embeddings, positional encodings, attention scores, and feed-forward activations to obtain, for each input position, a distribution over possible next tokens.

The server applies a decoding algorithm to iteratively select output tokens, for example by choosing the token with maximum probability or by sampling according to the probability distribution with constraints applied by temperature and top-k or top-p thresholds.

The server continues decoding until a stop condition is met, such as reaching a maximum token count or encountering a special end-of-sequence token.

The server decodes the resulting output token sequence back into a response character string using the tokenizer's reverse mapping.

The input of this step is the tokenized prompt sentence and model configuration; the output is a generated response character string produced by the generative AI model.

### Step 9:

The server performs content checking on the response character string by applying rule-based filters and pattern matching. The server scans the text for disallowed words, phrases, or patterns and, if found, either modifies or rejects the response and optionally triggers regeneration with adjusted parameters.

The server performs format adjustment by trimming leading and trailing whitespace, ensuring proper sentence punctuation, normalizing line breaks, and optionally adjusting numbering or bullet notation.

The server generates a text string for speech synthesis processing by finalizing the filtered and formatted response text.

The input of this step is the raw response character string from the generative AI model; the output is a cleaned and formatted text string for speech synthesis.

### Step 10:

The server determines a voice identifier to be used for speech synthesis, based on the voice_id received from the terminal or a default setting stored in the server.

The server looks up speaker feature information corresponding to the chosen voice identifier in a storage medium, retrieving an embedding vector or configuration parameters that represent voice characteristics such as timbre and pitch.

The server forms a TTS request structure containing the text string for speech synthesis processing, the voice identifier, language parameters, and any prosody control settings.

The input of this step is the text string for speech synthesis and the voice-related metadata; the output is a TTS request structure including text and voice parameters.

### Step 11:

The server sends the TTS request structure to a voice conversion processing apparatus, which may be a local TTS engine or a remote TTS service.

The server causes the TTS engine to execute text preprocessing, converting the text string into phonemes and linguistic features, and then to run an acoustic model that predicts acoustic feature sequences such as mel-spectrograms conditioned on the speaker feature information.

The server further causes a vocoder model within the TTS engine to convert the acoustic feature sequences into waveform samples, thereby generating audio data representing synthesized speech in the selected voice.

The input of this step is the TTS request structure with text and speaker features; the output is raw or encoded audio data representing the synthesized speech.

### Step 12:

The server optionally encodes the raw audio data into a compressed format such as a commonly used audio codec using an audio encoding library, reducing the data size for transmission.

The server packages the encoded audio data together with metadata such as sampling rate, duration, and content type into a response message.

The server transmits the response message to the terminal via the network interface using a communication protocol such as HTTPS.

The input of this step is the synthesized audio data from the TTS engine; the output is a transmitted response message containing encoded audio data.

### Step 13:

The terminal receives the response message from the server and extracts the encoded audio data and associated metadata.

The terminal decodes the encoded audio data using an audio codec provided by the operating system or an integrated multimedia library, converting it into PCM samples.

The terminal supplies the PCM samples to the acoustic output apparatus, such as a speaker or headphones, through the audio subsystem, and starts playback so that the user can hear the synthesized response in the selected voice.

The input of this step is the response message containing encoded audio data; the output is audible sound reproduced to the user.

### Step 14:

The user listens to the audio response and, if needed, decides to continue the interaction by entering a follow-up question or instruction on the terminal.

The terminal, upon receiving new input from the user, can repeat the above steps while reusing the existing conversation identifier, allowing the server to retrieve prior conversation history and include it in a new prompt sentence.

The input of this step is the perceived audio output; the output is a new cycle of user input that re-enters the processing pipeline, enabling continuous, context-aware dialogue.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional dialogue systems that utilize machine learning models to generate responses to user input typically process text in a uniform manner and output synthesized speech with a limited set of generic voices. In such systems, a computing device generally receives user text, forwards the text to a generative model, and then applies a text-to-speech engine that is not tightly integrated with user-specific context, user-selected voice types, or real-time emotional state of the user. As a result, these systems suffer from several technical limitations.

First, the processor must often perform multiple disjoint processing steps using loosely coupled software components, which leads to redundant data conversions and context reconstruction. For example, generative response computation is performed without consistent access to user interaction history, user-selected speaker characteristics, and emotion-related information, so the system repeatedly reformats or enriches the user input at higher application layers. This introduces additional processing overhead and network traffic, reduces response efficiency, and increases latency on resource-constrained devices such as mobile terminals.

Second, existing architectures do not natively integrate prompt construction for a generative AI model with downstream voice conversion logic in a single, coordinated control flow of the processor. The generative AI model is typically invoked with a relatively simple prompt that does not explicitly encode: (i) the user's past interaction history, (ii) the user-selected voice type to be used in speech synthesis, and (iii) emotion information inferred from the user's current input. As a result, the generated response text is not optimized for subsequent speech synthesis, causing mismatches between the content of the response and the speaking style that is ultimately rendered, and requiring additional post-processing or re-generation to obtain a more suitable output.

Third, many known systems do not perform integrated emotion analysis at the level of the server-side processor in a way that structurally modifies the prompt sentence given to the generative AI model. Emotion detection, if present, is often performed as a separate overlay function. This fragmented design forces multiple components to re-interpret the same user input independently, thereby consuming additional computation cycles, memory resources, and inter-process communication bandwidth. Such fragmentation degrades system robustness and scalability when a large number of concurrent users are served.

Fourth, from a computer-technology standpoint, there is no efficient mechanism in conventional systems for coordinating (a) server-side speech recognition output, (b) construction of a rich prompt sentence that embeds interaction history, selected voice type, and emotion state, and (c) selection of speaker-specific parameters for the speech synthesis unit. The absence of this coordination results in increased processor load, slower response times, and reduced throughput in multi-user, networked environments.

Accordingly, there is a need for an improved computer-implemented system in which a processor on a server side centrally manages: (i) transformation of user voice input into character information, (ii) construction and adjustment of a prompt sentence supplied to a generative AI model, (iii) integration of user interaction history and emotion state into that prompt sentence, and (iv) conversion of the generative AI model's response into an audio signal that has speaker characteristics corresponding to user-selected voice type information. Such a system should improve the efficiency, consistency, and responsiveness of the overall dialogue processing pipeline, while enabling scalable, personalized, and emotionally adaptive voice interactions using general-purpose computing resources.

The specific processing by the specific processing unit 290 of the data processing device 12 in Application Example 1 is realized by the following means.

The present invention provides a server comprising a processor configured to receive, from a terminal, audio information corresponding to voice input of a user; convert the audio information into character information by using a speech recognition unit under control of the processor; construct a prompt sentence on the basis of the character information and voice type information selected by the user on the terminal; input the prompt sentence into a generative AI model executed as a generative information processing component, and cause the generative AI model to generate response character information; convert the response character information into an audio signal having speaker characteristics corresponding to the voice type information by using a speech synthesis unit controlled by the processor; and transmit the audio signal to the terminal and control output of the audio signal to the user via an output device of the terminal, wherein the processor is further configured to acquire past interaction history information of the user and the voice type information from a storage device, adjust content of the prompt sentence on the basis of the past interaction history information and the voice type information so as to cause the generative AI model to generate personalized response character information, and cooperate with an emotion analysis unit that estimates emotion state information from the character information, add instruction information indicating an emotion-dependent response policy to the prompt sentence on the basis of the emotion state information, and cause the generative AI model to generate response character information corresponding to the emotion state information. This enables an integrated and technically efficient dialogue processing pipeline in which the server-side processor centrally manages speech recognition output, context-aware prompt sentence construction for the generative AI model, and voice-type-specific speech synthesis, thereby reducing redundant data processing, lowering response latency, improving utilization of computing and network resources, and providing scalable, personalized, and emotion-adaptive voice interactions in a computer system.

The term “processor” refers to a hardware or virtual computation element, such as a central processing unit or a processing core, configured to execute instructions for performing the functions described in the system.

The term “terminal” refers to an information processing apparatus, such as a mobile device, a personal computer, or another user-operated device, that acquires user input and presents output to the user.

The term “audio information” refers to data representing sound, including but not limited to digitized voice signals obtained by sampling acoustic waves through an input device.

The term “voice input” refers to information provided by a user in the form of spoken utterances that are captured as audio information by the terminal.

The term “user” refers to a human operator who interacts with the system by providing input and receiving output via the terminal.

The term “character information” refers to textual data, such as a sequence of characters or symbols, obtained by converting audio information or other input into a machine-readable text representation.

The term “speech recognition unit” refers to a software and/or hardware component configured to analyze audio information, perform acoustic and linguistic processing, and output corresponding character information.

The term “voice type information” refers to data that specifies a category or profile of a speaking voice, including but not limited to a particular speaker style, persona, or set of speaker characteristics to be used in speech synthesis.

The term “prompt sentence” refers to a text sequence that includes instructions and contextual information, provided as input to a generative AI model to control generation of response character information.

The term “generative AI model” refers to a machine-learned model, such as a neural network, configured to generate output character information based on input character information including a prompt sentence.

The term “generative information processing apparatus” refers to a computing resource or component that implements or hosts a generative AI model and performs generative processing in response to received prompts.

The term “response character information” refers to textual output generated by the generative AI model in response to a prompt sentence and representing a system response to user input.

The term “speech synthesis unit” refers to a software and/or hardware component configured to convert character information into audio signals, including text-to-speech engines and voice conversion modules.

The term “audio signal” refers to a time-varying signal, including but not limited to a digital waveform, representing sound that can be rendered as audible output.

The term “speaker characteristics” refers to attributes of a speaking voice, including but not limited to pitch, timbre, accent, speaking rate, and prosody, that define the perceived identity or style of a speaker.

The term “output device” refers to a component of the terminal, such as a loudspeaker or headphone interface, configured to convert audio signals into audible sound and present it to the user.

The term “past interaction history information” refers to stored data representing previous exchanges between the user and the system, including prior user inputs, system responses, timestamps, and associated context.

The term “storage device” refers to a memory component, such as a non-volatile storage or a database system, configured to store data including past interaction history information and voice type information.

The term “personalized response character information” refers to response character information generated by the generative AI model based at least in part on past interaction history information and/or user-specific parameters so as to be tailored to a particular user.

The term “emotion analysis unit” refers to a software and/or hardware component configured to estimate an emotional state from character information or related data using analysis techniques such as natural language processing or statistical modeling.

The term “emotion state information” refers to data indicating an inferred emotional condition, such as happiness, sadness, anxiety, or other affective states, associated with user input.

The term “instruction information” refers to additional control data or directives incorporated into a prompt sentence to influence how the generative AI model generates response character information.

The term “emotion-dependent response policy” refers to a set of rules or guidelines specifying how the content, tone, or style of a response should be adapted based on emotion state information.

In one embodiment, a server cooperates with one or more terminals operated by a user to implement a dialogue system that converts user voice input into personalized and emotion-adaptive synthesized speech by using a generative AI model and structured prompt sentences. The server executes a program that is stored in a non-transitory computer-readable medium and that causes a processor of the server to perform the functions described below. The terminal also executes application software that cooperates with the server over a communication network.

A terminal includes hardware such as at least one microphone, at least one loudspeaker or headphone interface, a display device, a wireless or wired communication interface, a main memory, and a local processor. The terminal uses an operating system, such as a mobile operating system or a desktop operating system, and an application layer implemented, for example, using a native application framework or a browser-based client. The terminal uses an audio input application programming interface, such as a system audio capture API, to sample analog voice input of the user and convert it into digital audio information. The terminal stores the sampled audio information in one or more buffers in a main memory in a format such as 16-bit linear pulse-code modulation at a sampling rate of 16 kHz or 44.1 kHz.

The terminal uses a speech recognition unit implemented as local software or as a client interface to a network-based speech recognition service. In one implementation, the terminal uses a speech recognition library that extracts acoustic features, such as mel-frequency cepstral coefficients or log-mel spectrograms, from the audio information and applies a trained neural network model, such as a connectionist temporal classification model or an encoder-decoder model with attention, to generate character information. The character information is a sequence of text tokens encoded in a character set such as Unicode. The terminal stores the character information in a text buffer and associates the text buffer with metadata including a timestamp and a language identifier.

The terminal presents a user interface that allows the user to select a voice type. The user uses a touch screen, a pointing device, or other input hardware to select one voice type from multiple voice type candidates displayed on the terminal. Each voice type is associated with voice type information, which may include an identifier of a speaker profile and parameters for pitch, speed, and prosody. The terminal transmits the character information and the voice type information to the server via a communication protocol such as Hypertext Transfer Protocol over a secure channel.

The server includes a processor, a main memory, a storage device, and a network interface. The storage device stores program instructions, a trained generative AI model, user interaction history information, voice type information, emotion analysis parameters, and configuration data. The server uses an operating system such as a server operating system and a runtime environment such as a virtual machine or a container system. The server uses a network stack implementing a transport protocol such as Transmission Control Protocol and an application protocol such as Hypertext Transfer Protocol.

The server stores the generative AI model as a set of trained parameters for a neural network architecture. In one embodiment, the generative AI model is a transformer-based language model including multiple encoder-decoder layers, self-attention mechanisms, and feedforward sub-layers. The model uses token embeddings, positional encodings, and layer normalization to process input tokens. The server loads the generative AI model into main memory and executes it on one or more processing units, such as central processing units and graphics processing units.

The server maintains a data structure for past interaction history information of each user. The data structure includes a sequence of records, each record including at least a user identifier, a time stamp, a past user utterance in character information form, a corresponding past response in character information form, and associated voice type information and emotion state information. The server stores the interaction history in a database system or a key-value store that allows retrieval by user identifier and time range.

The server implements a prompt construction module that generates a prompt sentence for the generative AI model. The server receives the character information and the voice type information from the terminal and retrieves, from the storage device, past interaction history information associated with the user. The server also communicates with an emotion analysis unit. The emotion analysis unit uses natural language processing techniques to infer an emotion state from the character information. The emotion analysis unit may use a classifier neural network that receives as input word embeddings of the character information and outputs a probability distribution over emotion categories, such as neutral, happy, sad, anxious, or angry. The classifier neural network may be trained using supervised learning with labeled text data, an objective function such as cross-entropy loss, and a gradient-based optimization method such as stochastic gradient descent or Adam. During training, the emotion analysis unit updates weights of the classifier neural network by minimizing the loss function between predicted emotion labels and ground truth labels, and uses techniques such as mini-batch training and dropout regularization to improve generalization.

The server constructs the prompt sentence by combining multiple elements into a structured text sequence. The server inserts instruction information into the prompt sentence to specify an emotion-dependent response policy and to encode information about the selected voice type. The server also embeds identifiers of past interaction history and summary text of past responses to maintain context across multiple turns. Examples of prompt sentences used by the server include:

“You are a helpful assistant. Answer the user's question in one or two concise sentences.
Question: ‘What is the weather today?’”
“You are a kind and supportive counselor. Give practical and empathetic advice in English.
Use a friendly and encouraging tone. Do not mention that you are an AI. User question: ‘I feel nervous before my presentation. What should I do?’”
“You are speaking as a cheerful fictional character. Answer in a playful and lighthearted tone.
Keep the answer short and easy to understand. User question: ‘Tell me a fun fact about space.’”

By explicitly encoding voice type information and emotion-dependent response policy into the prompt sentence, the server causes the generative AI model to generate response character information that is aligned with a subsequent speech synthesis process. This reduces the need for post-processing corrections and avoids multiple regeneration cycles.

The server passes the constructed prompt sentence to the generative AI model. The generative AI model receives the prompt sentence as a sequence of tokens and performs forward propagation through multiple transformer layers. Each transformer layer computes self-attention weights between tokens, performs matrix multiplications using weight matrices stored in memory, and applies non-linear activation functions. The model outputs probability distributions over possible next tokens at each step. The server uses a decoding algorithm, such as greedy decoding, beam search, or sampling with a temperature parameter, to select a sequence of output tokens and form the response character information. The server may apply constraints to the decoding process, such as maximum length, prohibited phrases, or punctuation rules, to ensure that the response is suitable for speech synthesis.

The server then prepares the response character information for a speech synthesis unit. The server may insert markup tags, such as tags to specify pauses or emphasis, into the response character information to further control prosody. The server passes the response character information, together with the voice type information, to the speech synthesis unit. The speech synthesis unit may be implemented as a neural text-to-speech system, such as a system using a sequence-to-sequence acoustic model and a neural vocoder. The acoustic model receives the response character information converted into phoneme or subword sequences, and also receives a speaker embedding vector corresponding to the selected voice type. The acoustic model generates an intermediate acoustic representation, such as a mel-spectrogram. The neural vocoder receives the acoustic representation and generates a digital audio signal that approximates a natural human voice with the desired speaker characteristics.

The server configures the speech synthesis unit to produce audio signals in formats suitable for the terminal, such as a compressed audio format or raw waveform data. The server transmits the audio signal to the terminal via the network interface. The terminal receives the audio signal and uses a media playback component to decode and output the audio signal through a loudspeaker or headphone interface.

This integrated architecture yields technical effects in the operation of the computer system. Because the server constructs the prompt sentence with explicit inclusion of voice type information, emotion state information, and past interaction history, the generative AI model receives more structured and relevant context in a single processing pass. This reduces the number of times the server must reformat or reissue prompts to correct responses, thereby reducing processor usage and network traffic. The server avoids repeated retrieval of context data by storing interaction history in an indexed data structure and by embedding relevant parts of that history into the prompt sentence. As a result, the system improves processing throughput and decreases end-to-end latency compared to a system that separately manages context, response generation, and voice adaptation.

The server also improves accuracy and consistency of response generation. The emotion analysis unit provides emotion state information derived from character information using a classifier that is trained with a specific loss function and feature representation. The prompt construction module uses this emotion state information in a rule-based or parameterized way to modify instruction information within the prompt sentence. For example, the server may add phrases such as “Use a calm and reassuring tone” or “Respond in a cheerful and energetic manner” depending on the inferred emotion. This non-conventional integration between emotion classification and prompt formulation results in response character information whose linguistic features better match the user's emotional context, which in turn improves the quality and stability of synthesized speech, because the speech synthesis unit receives text that is already structured for the intended emotional tone.

The system is not limited to a single neural network architecture. In some variations, the generative AI model may be a decoder-only transformer, and the emotion analysis unit may be a smaller transformer or recurrent network that shares an embedding space with the generative AI model. In another variation, the speech recognition unit may be implemented entirely on the server using a streaming recognition interface, while the terminal performs only basic audio capture and playback. In yet another variation, the speech synthesis unit may be executed on the terminal by downloading a voice model specialized for the selected voice type, in which case the server transmits response character information and voice type parameters instead of an audio signal.

The server improves computational efficiency by reusing intermediate representations and by batching operations. For example, when the server processes multiple requests for the same voice type, the server may reuse cached speaker embeddings or cached components of the generative AI model's hidden states. The server may schedule execution of the generative AI model and the speech synthesis unit on different hardware accelerators to parallelize processing. By optimizing the data flow between modules, the server reduces the number of memory copies and format conversions between character information and internal token representations, which reduces cache misses and improves CPU and GPU utilization.

The technical effects extend beyond simple automation of human tasks. A human operator cannot, manually and in real time, perform high-dimensional neural network computations, manage indexed data structures for past interaction history, construct prompt sentences conditioned on multiple parameter sets, and generate high-quality voice signals with consistent speaker characteristics at the speed and scale achieved by the described system. The server coordinates specific, non-conventional processing steps in which character information, emotion state information, and voice type information are combined in a formalized data structure (the prompt sentence) that is tailored to the internal architecture of the generative AI model and to the requirements of the speech synthesis unit. This coordination produces measurable improvements in processing speed, response accuracy, and resource utilization within the computer system.

In further embodiments, the server may apply additional optimization techniques, such as quantization of model weights, pruning of neural network layers, or dynamic adjustment of model depth based on the complexity of the prompt sentence. These techniques further reduce computational load and may be applied differently depending on the selected voice type or the detected emotion state, for example by using a deeper network for emotionally sensitive counseling content and a shallower network for simple factual questions. The server may also adjust sampling parameters, such as temperature or top-k values, based on the past interaction history to control variability of responses and improve user satisfaction without additional hardware.

Through these configurations, the server, the terminal, and the user cooperate in a system that implements a technically specific architecture for generative AI processing and voice synthesis, in which structured prompt sentence construction, emotion-aware control of the generative AI model, and voice-type-specific speech synthesis are integrated into a single coordinated process that improves the functioning of the underlying computer system.

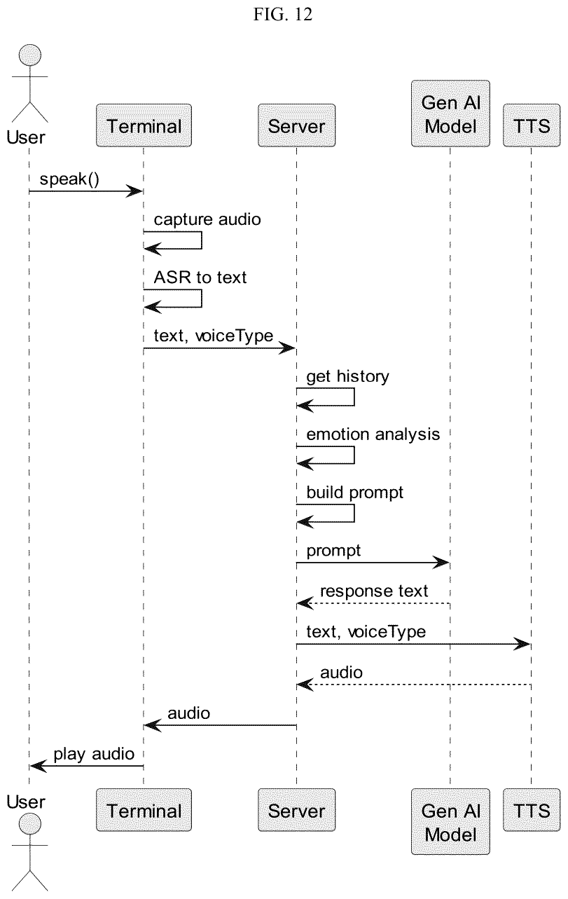

The following describes the processing flow using FIG. 12.

### Step 1:

The user provides voice input to the terminal.

The user speaks a question or statement toward the microphone of the terminal, such as “What is the weather today?” or “I feel nervous before my presentation. What should I do?”. The input of this step is an analog acoustic signal produced by the user's voice. The terminal receives the acoustic signal via its microphone hardware and converts it into digital audio data using an analog-to-digital converter. The terminal stores the resulting audio samples, for example 16-bit PCM at 16 kHz, in an audio buffer in main memory as the output of this step.

### Step 2:

The terminal converts audio information into character information.

The terminal passes the buffered audio data to a speech recognition unit implemented by a speech recognition library or service. The input of this step is the digital audio buffer produced in Step 1. The speech recognition unit extracts acoustic features (for example, mel-frequency cepstral coefficients or log-mel spectrogram frames) from overlapping windows of the waveform, and feeds these features into a trained neural network model such as a connectionist temporal classification model or an encoder-decoder model with attention. The terminal decodes the most probable sequence of text tokens corresponding to the spoken utterance by applying beam search or greedy decoding on the output probabilities of the model. The terminal then assembles these tokens into character information, for example a Unicode text string “What is the weather today?”, and stores this string in a text buffer. The output of this step is the character information representing the user's utterance.

### Step 3:

The terminal acquires or confirms voice type information.

The terminal displays, on its screen, a list or menu of voice type options that the user can select, such as “Voice type A,” “Voice type B,” or “Cheerful character voice.” The input of this step is a previously stored set of voice type candidates and any prior selection state for the user. The user interacts with the graphical user interface using a touch screen or pointing device to select a desired voice type. The terminal receives the selection event and maps the user's choice to voice type information, such as a voice identifier and associated parameters for pitch, speed, and style. The terminal stores this voice type information in application state as the output of this step.

### Step 4

The terminal transmits character information and voice type information to the server.

The terminal constructs a request payload that includes the character information from Step 2, the voice type information from Step 3, and optional metadata such as a user identifier and language code. The input of this step is the combination of the text buffer and the selected voice type information. The terminal serializes these data items into a structured format, for example a JSON object, and passes the serialized bytes to a network communication stack. The terminal uses a communication interface, such as a wireless or wired network adapter, to send the request to the server over a network using a protocol such as HTTPS. The output of this step is a network message containing the character information and voice type information delivered to the server.

### Step 5:

The server receives and parses the request from the terminal.

The server listens on a network port using a server application framework and receives an incoming request from the terminal. The input of this step is the network message transmitted in Step 4. The server's network stack reconstructs the application-layer message, and the server parses the serialized payload to extract fields such as the user identifier, the character information, and the voice type information. The server stores these fields in internal data structures, such as request objects or in-memory records, as the output of this step.

### Step 6:

The server retrieves past interaction history information for the user.

The server uses the user identifier obtained in Step 5 to query a storage device that maintains interaction history. The input of this step is the user identifier and possibly a time range or session identifier. The server issues a query to a database or key-value store to retrieve records that include past user utterances, previous responses, associated timestamps, and previously used voice types and emotion labels. The server processes the retrieved records to form a summarized history representation, such as a list of recent exchanges or a condensed text summary. The output of this step is past interaction history information associated with the current user.

### Step 7:

The server analyzes the emotion state from the character information.

The server provides the character information from Step 5 to an emotion analysis unit. The input of this step is the current user utterance in text form. The emotion analysis unit converts the character information into a sequence of token embeddings using a vocabulary and an embedding matrix, and feeds the embeddings into a trained classifier neural network, such as a transformer-based classifier or a recurrent neural network. The classifier computes hidden representations and outputs a probability distribution over discrete emotion categories, for example {neutral, happy, sad, anxious, angry}. The server selects the emotion category with the highest probability or applies a thresholding rule, and represents the result as emotion state information, such as “anxious” or “neutral,” possibly with a confidence score. The output of this step is the emotion state information associated with the current utterance.

### Step 8:

The server constructs a context-aware prompt sentence for the generative AI model.

The server uses the character information from Step 5, the voice type information from Step 5, the past interaction history information from Step 6, and the emotion state information from Step 7 to create a prompt sentence. The input of this step is the combination of these four information sources. The server applies a rule-based or template-based algorithm that inserts instruction information and context into a structured text sequence. For example, the server may generate a prompt sentence such as:
“You are a helpful assistant. Answer the user's question in one or two concise sentences.
Question: ‘What is the weather today?’”
or
“You are a kind and supportive counselor. Give practical and empathetic advice in English. Use a friendly and encouraging tone. Do not mention that you are an AI. The user is feeling anxious based on the following message. User question: ‘I feel nervous before my presentation. What should I do?’”
or
“You are speaking as a cheerful fictional character. Answer in a playful and lighthearted tone that matches the selected character voice. Keep the answer short and easy to understand. User question: ‘Tell me a fun fact about space.’”

The server may also append short summaries of recent exchanges to maintain conversational continuity. During this process, the server concatenates strings, inserts markers, and formats the text to comply with the expected input style of the generative AI model. The output of this step is a completed prompt sentence ready to be passed to the generative AI model.

### Step 9:

The server generates response character information using the generative AI model.

The server provides the prompt sentence from Step 8 as input to the generative AI model. The input of this step is the prompt sentence encoded as a sequence of tokens. The generative AI model converts the tokens into token embeddings, applies multiple layers of self-attention and feedforward transformations, and computes a sequence of output token probability distributions. The server applies a decoding algorithm, such as beam search or temperature-controlled sampling, to select output tokens in sequence, forming response character information. During this decoding, the server may enforce a maximum length and may stop generation when an end-of-sequence token appears. The output of this step is a text string that represents the model's response, for example “The weather today is sunny with a high of around 25 degrees Celsius and light winds.”

### Step 10:

The server optionally post-processes the response character information for speech synthesis.

The server receives the response character information from Step 9 and prepares it for the speech synthesis unit. The input of this step is the raw response text. The server adds punctuation if missing, inserts markup such as pause indicators or emphasis tags, and normalizes numbers, dates, or symbols into forms suitable for text-to-speech conversion. The server may also insert control phrases that align with the selected voice type and emotion state, while keeping them invisible to the user if necessary. The output of this step is a processed response text or annotated text sequence ready for conversion into an audio signal.

### Step 11:

The server converts the response character information into an audio signal with the selected voice type.

The server passes the processed response text from Step 10 and the voice type information from Step 5 to a speech synthesis unit. The input of this step is the combination of the processed response text and the selected voice parameters. The speech synthesis unit tokenizes the text into phonemes or subword units, generates an acoustic representation such as a mel-spectrogram via an acoustic model conditioned on a speaker embedding, and applies a neural vocoder to produce a digital waveform. The speaker embedding is determined according to the voice type information and defines characteristics such as timbre and pitch. The output of this step is an audio signal, for example a sequence of PCM samples or a compressed audio bitstream, that imitates the selected voice type.

### Step 12:

The server transmits the audio signal to the terminal.

The server encapsulates the audio signal produced in Step 11 into a response message. The input of this step is the digital audio data and optional metadata, such as the response character information for display. The server sets appropriate headers indicating the audio format and length, and uses its network interface and protocol stack to send the response message back to the terminal. The output of this step is a network message containing the audio signal delivered to the terminal.

### Step 13:

The terminal outputs the audio signal to the user.

The terminal receives the response message from the server and extracts the audio data. The input of this step is the network message from Step 12. The terminal passes the audio data to a media playback subsystem that decodes the bitstream, if compressed, and forwards the resulting PCM samples to the audio driver. The terminal drives a loudspeaker or headphone interface using the audio driver, thereby producing audible sound. The output of this step is the audible voice response that the user hears, rendered in the voice corresponding to the selected voice type.

### Step 14:

The server and terminal update interaction history for future use.

The server records, in its storage device, a new interaction record that includes the user's original character information, the response character information, the selected voice type information, the emotion state information, and timestamps. The input of this step is the set of data objects created in previous steps during the processing of the current interaction. The server inserts or updates records in the interaction history data structure, enabling efficient retrieval in subsequent sessions. In some embodiments, the terminal also stores a local subset of this history for quick reference or offline display. The output of this step is an updated interaction history that will influence future prompt sentence construction and system behavior.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional dialog systems that utilize machine learning or generative AI models typically treat user input as plain text and return a generic textual or audio response. In many architectures, the server simply forwards user text to a model and streams back the model's output, without a structured mechanism for dynamically constructing a prompt sentence, incorporating system-level instructions, or enforcing user-specific voice characteristics at the synthesis stage. As a result, the response generation pipeline is often rigid, difficult to personalize, and unable to consistently reflect user preferences or context across sessions. Moreover, existing systems frequently implement text processing, model invocation, and text-to-speech conversion as loosely coupled or separate components, which are not centrally orchestrated by a unified processor configuration. Such fragmentation can lead to redundant computation, inefficient use of computing resources, and increased latency, since context (such as user history, emotional state, or voice preference) is not coherently propagated through the entire pipeline. From a computer-technology standpoint, the data flow is suboptimal: the server does not systematically transform the user input and associated metadata into a well-formed prompt sentence, nor does it standardize the way that voice characteristic information configures the downstream audio generation process.

Additionally, in many existing solutions, user-specific personalization such as voice selection, speaking rate, or style is implemented only as a thin client-side setting or as a static configuration at the speech synthesis engine, rather than being programmatically managed and enforced by server-side logic. This limits the system's ability to perform fine-grained control over speech synthesis parameters based on dynamically computed context, leading to less efficient resource allocation and inconsistent user experience. The server is not technically optimized to integrate user identification, interaction history, emotional analysis, prompt construction, and voice parameter selection into one coherent, machine-executable workflow.

Further, there is a lack of mechanisms in conventional systems to automatically adjust the prompt sentence for a generative AI model based on stored interaction histories and inferred emotional states. This absence of structured prompt adjustment at the server reduces the effectiveness of the generative AI model, because the model is not systematically guided by context-aware instructions that could improve relevance, coherence, and safety of responses. Consequently, the computing system does not fully exploit the capabilities of the underlying hardware and models, resulting in unnecessary repetitions, degraded throughput, and suboptimal utilization of processing units.

Therefore, there is a need for a server-side architecture and processing configuration that (i) systematically acquires user information from a terminal, (ii) generates a context-aware prompt sentence for a generative AI model, (iii) manages and applies user-specific voice characteristics to a speech synthesis process, and (iv) transmits an audio signal to the terminal in a form that is efficiently generated and reliably reflects both the semantic content and the personalized voice settings. Such an architecture should improve the internal data transformations, reduce processing redundancy, and enhance overall performance and personalization of the human-computer interaction.

The specific processing by the specific processing unit 290 of the data processing device 12 in Example 2 is realized by the following means.

The present invention provides a server comprising a processor configured to acquire information from a user via a terminal, generate a prompt sentence including a request content of the user and an instruction content of the system based on the information, input the prompt sentence into a generative AI model to cause the generative AI model to generate a text response, manage voice characteristic information of the user, select at least one of a speaker attribute, a speaking rate, a pitch, and a speaking style for a speech synthesis process based on the voice characteristic information, input the text response into the speech synthesis process to generate an audio signal reflecting the voice characteristic information, and transmit the audio signal to the terminal as audio data reproducible on the terminal. This enables the server to perform a unified, processor-controlled pipeline that transforms user input, contextual data, and personalization parameters into a structured prompt sentence for the generative AI model and into precisely configured speech synthesis parameters, thereby improving computational efficiency, reducing latency, and providing a technically enhanced, personalized audio interaction experience.

The term “system” refers to a combination of one or more computing devices and associated components that cooperate to execute the functions described in the claims, including at least one processor, memory, communication interfaces, and software modules. The term “processor” refers to one or more processing units, such as a central processing unit, a graphics processing unit, a digital signal processor, or any other programmable data processing circuitry capable of executing instructions to perform the claimed operations. The term “user” refers to a human operator or an entity that provides input to the system and receives output from the system through a terminal or other interface device.

The term “terminal” refers to an information processing apparatus, such as a mobile device, a personal computer, a tablet device, or another client device, configured to send user information to the server and to output audio or visual information to the user.

The term “information” refers to data received from the user or the terminal, including but not limited to textual input, voice input converted to text, configuration data, identification data, and preference data.

The term “request content” refers to a semantic content of the information provided by the user, including a question, a command, a request for information, or any other intent that the user wishes the system to process.

The term “instruction content of the system” refers to control information, constraints, or guidelines determined by the system for guiding the behavior of a generative AI model, including, for example, target style, response length, safety constraints, and output format.

The term “prompt sentence” refers to a text sequence generated by the processor that includes at least part of the request content and at least part of the instruction content of the system, and that is provided as input to a generative AI model to cause the generative AI model to generate a response.

The term “generative AI model” refers to a machine learning model configured to generate output data such as text based on input data, the model including, for example, a neural network model such as a language model, a sequence-to-sequence model, or another generative model.

The term “text response” refers to text data generated by the generative AI model in response to a prompt sentence and representing the content that is to be communicated to the user.

The term “voice characteristic information” refers to data representing one or more user-specific preferences or system-determined attributes regarding audio output, including, for example, a speaker attribute, a speaking rate, a pitch, and a speaking style.

The term “speaker attribute” refers to a parameter representing characteristics of a virtual speaker, such as gender, age category, timbre, or identity of a synthesized voice.

The term “speaking rate” refers to a parameter indicating the speed at which synthesized speech is to be produced, for example in terms of words per minute or a relative speed factor.

The term “pitch” refers to a parameter indicating the fundamental frequency or perceived height of a synthesized voice, and may be represented, for example, as an absolute frequency or a relative change in semitones.

The term “speaking style” refers to a parameter defining prosodic and expressive characteristics of synthesized speech, including but not limited to formality level, emotional tone, emphasis pattern, and rhythm.

The term “speech synthesis process” refers to a procedure, executed by software and hardware, that converts text data into audio data representing speech, using algorithms such as text-to-speech synthesis.

The term “audio signal” refers to data representing sound, including, for example, digital waveform data that encodes speech for subsequent playback by an audio output device.

The term “audio data reproducible on the terminal” refers to audio information encoded in a format that can be decoded and played back by the terminal's hardware and software, such as a compressed or uncompressed digital audio file or stream.

The term “identification information of the user” refers to data that uniquely or pseudo-uniquely associates interaction data with a particular user, such as a user ID, an account identifier, or a session identifier.

The term “past interaction history data” refers to stored data representing previous exchanges between the user and the system, including prior user inputs, system responses, and associated metadata.

The term “output condition” refers to a constraint or parameter that specifies how the generative AI model should produce its output, including, for example, length limitations, style requirements, language selection, or formatting rules.

The term “emotional state” refers to an inferred or detected affective condition of the user, such as happiness, sadness, anger, calmness, or other emotional categories, derived from input data such as text or voice.

The term “input data of the user” refers to any data provided by the user to the system, including text entered via a user interface, voice captured and converted to text, or other signals indicative of the user's intent or state.

The term “voice quality” refers to acoustic characteristics of synthesized speech that influence its overall timbre and perception, including aspects such as warmth, sharpness, breathiness, and clarity.

The term “response corresponding to the emotional state” refers to a text response generated by the generative AI model that is adapted in content, wording, or style to match or appropriately address the inferred emotional state of the user.

In one embodiment, a server cooperates with one or more terminals operated by a user to provide a personalized audio response service using a generative AI model. The server includes at least one processor, a memory device storing programs and data structures, a communication interface, and an audio output module. The terminal includes at least one processor, a memory device, a user interface display, an audio output device such as a loudspeaker or headphones, and a communication interface such as a wireless transceiver.

The server executes an operating system such as a general-purpose server operating system and runs application software implemented, for example, using a web framework or an application framework. The server optionally uses a hardware accelerator such as a graphics processing unit to execute neural network inference for the generative AI model. The terminal executes a client application implemented, for example, as a native mobile application or a web-based application, which sends user information to the server and receives audio data from the server.

The server stores in the memory a program that implements at least the following functional modules: a user information acquisition module, a prompt sentence generation module, a generative AI model interface module, a voice characteristic management module, a speech synthesis control module, and a communication control module. The server also stores user-related data such as identification information, past interaction history data, and voice characteristic information in a structured storage device, for example in a relational or non-relational data store.

The terminal captures user input using a touch interface, a keyboard, or a microphone. When the user speaks, the terminal uses speech recognition software included in an operating system or a browser to convert audio data into text data. The terminal then transmits the text data and associated metadata, such as a user identifier and current voice preferences, to the server using a secure communication protocol. The terminal displays intermediate information, such as the recognized text and a status indicator that the server is processing the request, so that the user can understand the system status.

The user specifies voice characteristic information on the terminal by selecting a preferred voice style, such as “female, calm, medium speed” or “male, energetic, fast speed,” via graphical elements such as buttons, lists, or sliders. The terminal converts these selections into parameter values, such as a speaker attribute code, a speaking rate factor, a pitch offset, and an emotion or style identifier. The terminal sends these parameter values to the server as part of a configuration payload. The terminal updates and stores local copies of these settings so that they can be reused in subsequent sessions.

The server receives the user's text information and voice characteristic parameters through the communication control module. The server stores the received data in memory in predetermined data structures, such as objects containing fields for user identifier, textual content, timestamp, and voice characteristic vector. The server then uses the user information acquisition module to associate the received data with a user record in the storage device, using identification information provided by the terminal. The server updates a past interaction history table or collection with the new input and optionally with the response that will be generated.

The server uses the prompt sentence generation module to construct a prompt sentence for the generative AI model. In this embodiment, the server uses a combination of rule-based templates and dynamic insertion of user-specific and context-specific variables. The server refers to the past interaction history data corresponding to the user identifier, retrieves relevant previous queries and responses, and analyzes them using text processing functions. For example, the server performs tokenization, part-of-speech tagging, and semantic similarity estimation using vector representations to identify whether the current input relates to a previous topic.

The server generates a prompt sentence by combining the user's current request content, system-level instructions, and optionally summaries of recent context. For example, if the user input is “Tell me tomorrow's weather,” the server constructs a prompt sentence such as:
“Please answer in one short sentence: What will the weather be like tomorrow for the user's current location?”

If the user input is “Explain generative AI,” the server constructs a prompt sentence such as:
“In simple English, explain what a generative AI model is in no more than three sentences.”

If the user input is “Summarize today's news about renewable energy,” the server constructs a prompt sentence such as:
“Summarize today's major news about renewable energy in three concise bullet points. Respond in English.”

The server optionally modifies the prompt sentence using personalization information. For example, when the past interaction history data indicates that the user tends to prefer concise technical explanations, the server adds an instruction such as:
“Provide a concise, technically accurate explanation suitable for a user familiar with basic computer science.”

When the server detects from past data that the user prefers a specific style, such as a narrative style, the server may add an instruction such as:
“Use a friendly and slightly narrative style while remaining accurate and brief.”

The server uses the generative AI model interface module to provide the prompt sentence to a generative AI model. The server can host the generative AI model locally or access it as a network service. In one embodiment, the server uses a transformer-based neural network architecture as the generative AI model. The model includes an input embedding layer, a plurality of self-attention layers, feed-forward subnetworks, and an output projection layer that maps internal representations to token probabilities. The model parameters are stored in the memory or in a storage device and are loaded into processor-accessible memory for inference. The server uses an inference engine or a deep learning framework to perform efficient matrix multiplications and attention computations on a central processing unit or a graphics processing unit.

The server causes the generative AI model to generate a text response by performing tokenization on the prompt sentence, mapping tokens into numerical indices, and feeding the token sequence into the neural network. The server controls generation parameters such as maximum number of output tokens, temperature, and top-k or top-p sampling thresholds. The server obtains probability distributions over the vocabulary for each output step, selects tokens according to the specified sampling strategy, and decodes the resulting token sequence into text data. The server can implement post-processing rules, such as removing incomplete sentences or truncating output beyond a specified length.

The server optionally uses a safety or content filter module that applies a classifier network or rule-based pattern matching to assess whether the generated text response violates predefined policies. The server can, for example, compute an embedding of the response and compare it against embeddings of disallowed content, or use a separate classifier trained with supervised labels. When the server detects an issue, the server can regenerate the response with a modified prompt sentence that includes additional constraints.

The server stores the generated text response in the memory and updates the past interaction history data with the new response. By storing both user inputs and generated responses, the server supports future context-aware prompt generation and continuous personalization. The server associates each stored entry with metadata such as timestamp, context topic identifier, and emotion label.

The server uses the voice characteristic management module to process the voice characteristic information of the user. The server maps a high-level preference, such as “female, calm, medium speed,” to a specific set of speech synthesis parameters, including a voice model identifier, a speaking rate factor, a pitch shift parameter, and a style identifier representing prosodic patterns. The server maintains a mapping table in the storage device that associates user identifiers with their preferred parameter sets. The server also allows default parameter sets for users without explicit preferences.

The server uses the speech synthesis control module to convert the text response into an audio signal. In one embodiment, the server uses an external text-to-speech engine accessed via a network protocol. In another embodiment, the server hosts a neural network-based text-to-speech engine on the server hardware. The neural network-based text-to-speech engine can follow an architecture that includes a sequence-to-sequence module for converting text into intermediate acoustic features, such as mel-spectrograms, and a vocoder module for converting the acoustic features into time-domain waveforms. The sequence-to-sequence module may use an attention-based mechanism or a non-autoregressive architecture. The vocoder module may use a convolutional or autoregressive network optimized for waveform generation.

The server converts the text response into a phoneme or grapheme sequence, applies prosodic modeling based on the speaking rate, pitch, and speaking style parameters, and generates an acoustic feature sequence. The server then feeds the acoustic feature sequence into the vocoder to generate an audio waveform. The server prints the waveform into a digital audio format, such as a pulse-code modulation representation at a sampling rate suited for playback on the terminal. The server may further process the waveform to normalize volume, apply noise reduction, or encode the waveform into a compressed format, such as a commonly used audio compression scheme.

The server transmits the audio signal as audio data to the terminal via the communication control module. The server controls packetization, buffering, and streaming according to the network conditions. For example, the server may stream audio in segments, so that the terminal can start playback before the entire file is transmitted. This streaming approach reduces perceived latency and improves responsiveness for the user. The server sends metadata such as the audio encoding format and duration, allowing the terminal to set up appropriate decoders and playback controls.

The terminal receives the audio data, decodes it using audio codecs provided by the operating system or the application framework, and sends the decoded audio samples to an audio output device. The terminal renders the audio in real time or near real time, so that the user hears the generated response in the selected voice style. The terminal may display associated textual information, such as a transcript of the response, and may provide controls for pausing, resuming, or stopping playback.

The server improves computer technology by optimizing internal data structures and control flows that connect user input, prompt sentence generation, generative AI model inference, and speech synthesis. By structuring user information, past interaction history, and voice characteristics into explicit data objects and by defining a deterministic pipeline for constructing prompt sentences and speech synthesis parameters, the server reduces redundant computation and avoids repeated natural language reformulation on the client side. The server, instead of merely automating a human operator's conversation, reorganizes computation in a way that leverages the parallel processing capabilities of hardware accelerators and avoids unnecessary data transfers between client and server.

The server reduces latency and improves throughput by generating prompt sentences that are constrained in length and content, thereby lowering the number of tokens processed by the generative AI model and reducing the load on the neural network inference engine. By maintaining per-user history summaries and context identifiers, the server can synthesize compact context representations that are inserted into the prompt sentence instead of re-supplying lengthy conversation transcripts. This condensed representation improves inference speed and reduces memory consumption.

The server enhances accuracy and personalization by adjusting the prompt sentence based on past interaction history and inferred emotional state. The server does not simply replicate human decision-making but uses numerical similarity measures, emotion classification network outputs, and rule-based template selection to programmatically reconstruct an optimal instruction set for each call to the generative AI model. For example, the server can encode an emotional state as a categorical label or a continuous vector, and this label or vector influences the wording of the system-level instruction portion of the prompt sentence, thereby guiding the model to produce content that is more aligned with the user's inferred needs.

The server uses a distinct training process for the generative AI model and auxiliary classifiers. During training, the server or an associated training system applies a loss function such as cross-entropy loss for language modeling and an additional loss term for style or safety adherence. The training process uses gradient-based optimization to update the weights of the transformer layers. The server, during inference, employs the trained weights without further modification, but the server controls the input prompt structure and sampling parameters to obtain outputs that match the technical constraints. By designing the prompt sentence generation procedure and the sampling control parameters, the server modifies the effective behavior of the neural network without retraining, which allows for rapid adaptation to new usage scenarios.

The server further uses a structured data flow where each module has explicitly defined input and output formats. For example, the prompt sentence generation module outputs a string and a metadata object; the generative AI model interface outputs a text response and quality scores; the voice characteristic management module outputs a parameter vector; and the speech synthesis control module outputs waveform data and format identifiers. This modular design allows the server to switch between different text-to-speech engines, generative AI models, or communication protocols without altering the functional logic of other modules, thereby improving maintainability and scalability of the system.

The server, by centrally managing voice characteristic information and enforcing it at the speech synthesis level, reduces the need for multiple redundant configurations at the terminal or at each speech synthesis engine instance. This centralization allows the server to cache frequently used audio parameter sets and reuse them, reducing computation when generating similar responses for the same user. The server can also batch multiple text-to-speech requests with identical or similar voice characteristics, enabling optimized use of hardware resources and further reducing processing time.

In alternative embodiments, the server can support multiple generative AI models with different architectures or capacities. The server can select a model dynamically based on factors such as the length or complexity of the user request, the current system load, or a service level associated with the user. For short or simple requests, the server may use a smaller, faster model; for complex explanations, the server may use a larger, more accurate model. This model selection reduces overall resource consumption while maintaining sufficient response quality.

In another embodiment, the server supports multiple speech synthesis engines, including both neural network-based engines and conventional concatenative or parametric engines. The server selects an engine based on factors such as the target language, desired latency, or licensing constraints. For example, the server may use a neural vocoder for high-quality, expressive speech, and a simpler synthesizer for short notifications. The voice characteristic management module maps high-level voice preferences to engine-specific parameter sets, enabling seamless switching between engines without changing the user interface or the calling application.

The terminal, in additional embodiments, may perform preliminary processing, such as local emotion detection from the user's voice or facial expression when appropriate sensors are available. The terminal can send these preliminary emotion estimations to the server as part of the input data. The server can combine local emotion estimations with server-side text-based emotion inference to improve the robustness and accuracy of emotional state detection. This cooperative processing reduces server load and improves response time, while maintaining centralized control over final decision-making and prompt sentence generation. Through these embodiments, the server, the terminal, and the user cooperate in a system that does more than automate a human operator's conversation. The system improves internal computer operations by structuring data, controlling neural network input and output, optimizing text-to-speech parameterization, and managing communication in a way that reduces computational overhead, lowers latency, enhances personalization accuracy, and improves the reliability of audio delivery across heterogeneous devices.

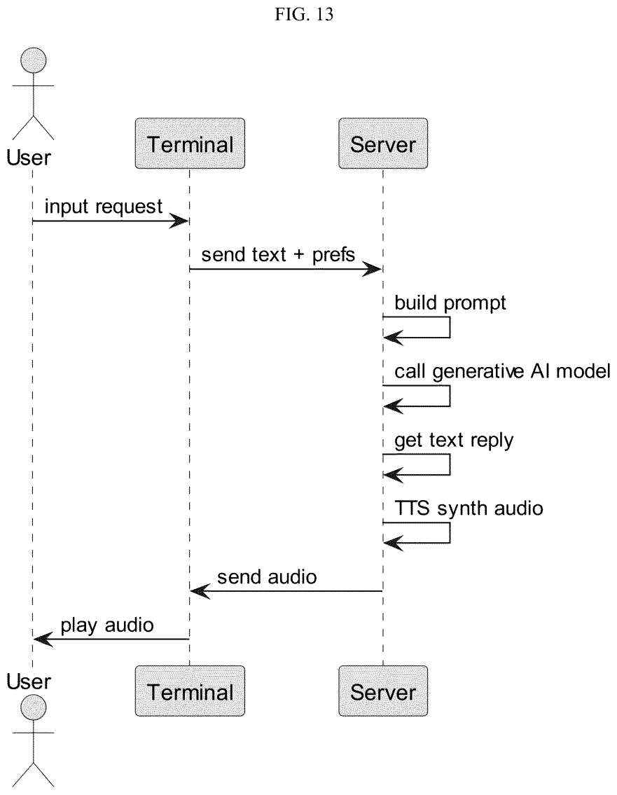

The following describes the processing flow using FIG. 13.

### Step 1:

The user operates the terminal and inputs a request.

The user provides input as text via a keyboard or touch screen, or as speech via a microphone. The terminal receives this raw input (text string or audio waveform) as the input of Step 1. The terminal, when receiving audio, executes speech recognition software to convert the audio waveform into a text string, and when receiving typed text, normalizes character encoding and line breaks. The terminal outputs a normalized text request, such as “Tell me tomorrow's weather,” together with user identification information and current voice preference settings as the output of Step 1.

### Step 2:

The terminal prepares a request payload and transmits it to the server.

The terminal takes as input the normalized text request, the user identification information, and the voice preference data from Step 1. The terminal constructs a structured payload containing fields such as user ID, text content, timestamp, and a voice parameter vector (for example, desired speaker type, speaking rate, and pitch). The terminal encodes this payload into a data format, attaches authentication information, and sends it to a designated server endpoint via a communication protocol. The terminal outputs a network request containing the user text and configuration data as the output of Step 2.

### Step 3:

The server receives the request payload and validates the data.

The server accepts as input the network request sent by the terminal in Step 2. The server parses the request headers and body, verifies authentication tokens, and checks that required fields such as user ID and text content are present and within allowed size limits. The server performs data type checks and sanitization on the text to remove control characters or unsupported symbols. The server outputs a validated user request object containing clean text data, user identification information, and voice parameter values as the output of Step 3.

### Step 4:

The server retrieves user profile data and past interaction history.

The server uses as input the validated user request object from Step 3, including the user identification information. The server queries a storage device, such as a structured data store, to retrieve user profile records and past interaction history data associated with the user ID. The server may load previous queries, previous responses, stored preference records, and context tags. The server performs data aggregation, for example by selecting the most recent N interactions and computing simple statistics such as average response length or preferred style. The server outputs a combined context object that includes the current user request, profile information, and summarized interaction history as the output of Step 4.

### Step 5:

The server analyzes the current request and constructs a prompt sentence.

The server takes as input the combined context object generated in Step 4. The server applies natural language processing operations, such as tokenization, part-of-speech tagging, and intent classification, to the current text request. The server computes similarity scores between the current request and past interaction entries using vector representations, and determines whether specific contextual information should be referenced. Based on these analyses, the server selects a template and fills template slots with the user's request content, context summaries, and system instructions. For example, the server may generate a prompt sentence such as:
“Please answer in one short sentence: What will the weather be like tomorrow for the user's current location?”

The server outputs a prompt package containing the constructed prompt sentence and associated control parameters (maximum length, desired style, language) as the output of Step 5.

### Step 6:

The server invokes the generative AI model and generates a text response.

The server receives as input the prompt package from Step 5. The server performs tokenization on the prompt sentence, converting the text into a sequence of token identifiers, and feeds this sequence into a transformer-based generative AI model. The server sets generation parameters such as maximum token count, temperature, and sampling strategy, and executes neural network inference to compute probability distributions over the vocabulary at each generation step. The server selects output tokens according to the configured strategy, assembles them into a token sequence, and decodes the token sequence back into a text string. The server optionally applies post-processing rules, such as trimming trailing fragments and ensuring proper sentence termination. The server outputs a text response, for example “Tomorrow will be sunny with mild temperatures and a light breeze,” together with quality metrics or flags as the output of Step 6.

### Step 7:

The server performs content filtering and logs the interaction.

The server takes as input the text response and quality metrics produced in Step 6, together with the original user request and context. The server applies filtering logic, which may include rule-based pattern checks and classifier outputs, to detect disallowed or low-quality content. If the server detects an issue, the server may regenerate the response using a modified prompt sentence that adds stricter instructions; otherwise, the server accepts the response. The server writes the user request, the final text response, and relevant metadata (timestamp, model version, prompt parameters) into a past interaction history store. The server outputs a finalized text response and an updated interaction history record as the output of Step 7.

### Step 8:

The server resolves and updates voice characteristic information.

The server uses as input the finalized text response from Step 7 and the voice preference data included in the validated request object from Step 3, along with any persistent voice settings stored in the user profile. The server combines these data to generate a voice parameter set, which may include a voice model identifier, speaking rate value, pitch offset, and speaking style identifier. If the user has updated preferences, the server updates the stored voice profile in the storage device. The server outputs a consolidated voice configuration object that reflects both the user's latest preferences and any default or fallback parameters as the output of Step 8.

### Step 9:

The server converts the text response into an audio signal using speech synthesis.

The server accepts as input the finalized text response from Step 7 and the consolidated voice configuration object from Step 8. The server invokes a speech synthesis engine, which may be a neural text-to-speech model, and provides the text response along with parameters such as the selected speaker attribute, speaking rate, pitch, and speaking style. The server performs text normalization and phoneme or grapheme conversion, then generates intermediate acoustic features and passes them to a vocoder to compute a digital audio waveform. The server may apply audio post-processing operations such as volume normalization and encoding to a desired audio format. The server outputs encoded audio data representing the synthesized speech, along with format metadata such as sampling rate and codec type, as the output of Step 9.

### Step 10:

The server prepares and sends the audio response to the terminal.

The server uses as input the encoded audio data and format metadata from Step 9, together with addressing information of the terminal from the original request. The server constructs a response message that includes the audio payload and appropriate headers indicating content type and length. The server may divide the audio into segments for streaming and sets buffering and chunk sizes based on network conditions or configuration. The server transmits the response message or stream over the communication channel to the terminal. The server outputs a delivered audio response over the network as the output of Step 10.

### Step 11:

The terminal receives, decodes, and plays back the audio.

The terminal takes as input the audio response message or stream sent by the server in Step 10. The terminal parses the headers to determine the audio format, allocates buffers for receiving the audio data, and passes the data to an audio decoding component. The terminal decodes the compressed audio into raw audio samples and forwards these samples to an audio output device such as a loudspeaker or headphones. The terminal may display playback controls and a visual indication that audio is being played. The terminal outputs audible sound that presents the server-generated response to the user as the output of Step 11.

### Step 12:

The user listens to the response and optionally provides follow-up input.

The user receives as input the audible sound produced by the terminal in Step 11. The user evaluates the content and voice characteristics, and, if further information or clarification is desired, provides a new input to the terminal using the same interaction mechanisms as in Step 1. Based on this new input, the terminal again collects text and preference data. The user thereby outputs a new request to the terminal as the output of Step 12, which can be used as the input for a subsequent iteration of the processing flow.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional dialog systems and content delivery systems that utilize machine learning models generally treat the path from user input to audio output as a loosely coupled chain of independent components: automatic speech recognition, natural language understanding or generation, and text-to-speech synthesis. In such systems, a generative AI model is typically given only a direct transcription of the user's input, without structured prompt engineering that systematically encodes dialog history, user attributes, and emotional state. As a result, the generated responses are often generic, weakly personalized, and insensitive to the user's emotional context.

Furthermore, existing architectures usually pass the output text from the language model to a speech synthesis engine in a manner that is largely static: the speech synthesis engine is configured with a fixed voice and limited prosodic control, and the emotional state inferred from the user input is not tightly integrated into the generation of either the textual content or the acoustic parameters. In many cases, emotion analysis, if present at all, operates as a loosely attached post-processing step that does not inform the generative AI model's internal reasoning via an explicit, structured prompt sentence.

Such separation of processing stages leads to several technical problems. First, the system cannot reliably produce consistent and context-aware responses across multi-turn interactions, because the generative AI model is not systematically guided by a machine-constructed prompt that encodes dialog history and user-specific information in a standardized way. Second, the lack of joint control over textual generation and acoustic rendering prevents efficient mapping from detected emotions to concrete, machine-controlled acoustic parameters (such as speaking rate, prosody, and volume), resulting in responses that sound unnatural or emotionally incongruent. Third, when each component is configured independently, computing resources are wasted on repeated or redundant processing, and the system may suffer from latency, inconsistent behavior, or fragile integration logic.

Therefore, there is a need for an improved computer-implemented system and method in which a processor centrally manages user input normalization, emotion analysis, dynamic prompt sentence construction for a generative AI model, and controlled speech synthesis or voice conversion based on both semantic and emotional information. By integrating these stages into a coordinated processing pipeline managed by a single processor, it becomes possible to enhance the technical performance of the dialog system, including improved coherence of responses over time, reduced mismatch between content and prosody, and more efficient utilization of computation and network resources.

The specific processing by the specific processing unit 290 of the data processing device 12 in Application Example 2 is realized by the following means.

The present invention provides a server comprising a processor configured to receive voice information or character information from a user, convert the voice information from an acoustic signal into a character string, generate user information including the character string and user attribute information, construct a prompt sentence for causing a generative information processing model to generate a response sentence based on the user information and past dialogue history information, input the prompt sentence into the generative information processing model to acquire a response character string, perform emotion analysis processing on the voice information or the character information to extract emotional state information, dynamically modify the prompt sentence based on the emotional state information and the past dialogue history information so as to cause the generative information processing model to generate a personalized response character string, and input the response character string, together with voice characteristic designation information including at least one of speaking rate, prosody, and sound volume corresponding to the emotional state information, into a speech synthesis processing algorithm or a voice conversion processing algorithm to generate an acoustic signal having a predetermined speaker characteristic or emotional characteristic, and transmit the acoustic signal to a terminal device for presentation to the user via an acoustic output unit. This enables a computer-implemented dialog system to technically improve generation and delivery of audio responses by centrally coordinating emotion-aware prompt construction for a generative AI model and parameterized speech synthesis, thereby achieving more coherent multi-turn interaction, reduced mismatch between textual content and acoustic expression, and more efficient processing of user-specific and context-specific information within the computing infrastructure.

The term “voice information” refers to information representing sound produced by a user, including analog or digital acoustic signals acquired via a sound input component and suitable for processing by an automatic speech recognition function or an emotion analysis function.

The term “character information” refers to information representing symbols of a writing system, including text strings input by a user via a graphical user interface or generated by a speech recognition function, and suitable for processing by a language analysis function.

The term “acoustic signal” refers to a time-varying signal representing sound, including analog waveforms and digitized audio data, which can be analyzed or synthesized by a computing apparatus.

The term “character string” refers to an ordered sequence of characters encoded in a computer-readable format, representing words, sentences, or other linguistic units processed by a text-handling function.

The term “user information” refers to data associated with a user, including at least a character string derived from user input and attribute information indicating properties of the user or of the interaction context.

The term “user attribute information” refers to data describing characteristics of a user or the user's environment, including at least one of language preference, voice preference, device type, location category, demographic category, or historical usage pattern.

The term “past dialogue history information” refers to stored data representing previous interaction turns between a user and a system, including prior user inputs, system responses, associated emotional state information, and timestamps.

The term “prompt sentence” refers to a natural-language or structured instruction string constructed by a processor and provided as input to a generative information processing model, the instruction string specifying at least a task, a context, and constraints for generation of a response.

The term “generative information processing model” refers to a machine-learned model that receives a prompt sentence and optionally additional context as input and generates new character strings as output using statistical or neural generative techniques.

The term “response sentence” refers to at least one character string generated by a generative information processing model in response to a prompt sentence, the character string representing an answer, a message, or content to be delivered to a user.

The term “response character string” refers to textual output generated by a generative information processing model, including one or more response sentences encoded as a sequence of characters suitable for further processing.

The term “emotion analysis processing” refers to computational processing that estimates an emotional state from input data, including at least one of voice information, character information, or multimodal features, using a rule-based or machine-learned classifier.

The term “emotional state information” refers to data indicating an inferred affective condition of a user, including categories such as joy, sadness, stress, anger, or calmness, and optionally including intensity scores or confidence values.

The term “personalized response character string” refers to a response character string generated by a generative information processing model under conditions specified by a prompt sentence that encodes user-specific data, dialog history, or emotional state information so that the content is adapted to a particular user.

The term “voice characteristic designation information” refers to control data specifying desired acoustic properties for synthesized speech, including at least one of speaker identity category, speaking rate, prosody pattern, pitch contour, timbre, and sound volume.

The term “speaker characteristic” refers to properties of synthesized or converted speech that correspond to attributes of a notional speaker, including at least one of perceived identity, gender category, age category, and accent category.

The term “emotional characteristic” refers to acoustic properties of synthesized or converted speech that express or imply an affective state, including changes in speaking rate, pitch variation, energy level, and phrasing patterns.

The term “speech synthesis processing algorithm” refers to a computational procedure that converts a character string or linguistic representation into an acoustic signal representing speech, using at least one of concatenative synthesis, parametric synthesis, or neural waveform generation.

The term “voice conversion processing algorithm” refers to a computational procedure that transforms a source speech representation or a text-based representation into an acoustic signal that mimics target voice characteristics, including target speaker characteristic or emotional characteristic.

The term “speaking rate” refers to a temporal parameter of synthesized speech indicating the speed at which phonetic units, syllables, or words are produced in an acoustic signal.

The term “prosody” refers to suprasegmental aspects of speech including at least pitch contour, rhythm, stress pattern, and intonation pattern that influence perceived expressiveness and emphasis.

The term “sound volume” refers to an amplitude-related parameter of an acoustic signal, representing perceived loudness of synthesized or converted speech as controlled by a signal level or gain setting.

The term “terminal device” refers to an information processing apparatus used by a user to interact with a server, including at least one of a mobile communication device, a wearable device, a kiosk, or a general-purpose computing device, equipped with input and output components.

The term “acoustic output unit” refers to a component of a terminal device configured to output sound, including at least one of a loudspeaker, an earphone, a headphone, or another electroacoustic transducer.

According to one embodiment, a server implements the claimed system by executing a program on one or more general-purpose processors. The server is connected to at least one terminal via a communication network. The terminal is, for example, a mobile communication device, a wearable device, or a kiosk-type information processing apparatus equipped with a microphone, a loudspeaker, a display, and a network interface.

The server uses conventional server hardware such as a multi-core x86 processor, a main memory, a non-volatile storage device, and a network interface card. The server runs an operating system such as a general-purpose server operating system and a web application framework. The server executes application modules that implement a speech recognition function, an emotion analysis function, a generative AI model interface, and a speech synthesis or voice conversion function.

The terminal captures voice information from a user using the microphone and converts the analog sound into a digital acoustic signal using an audio codec. The terminal may encode the acoustic signal as linear PCM or a compressed codec and then transmit the encoded data to the server via a network protocol such as HTTPS. The terminal may also transmit character information directly to the server when the user inputs text via a graphical user interface.

The server receives the acoustic signal or the character information and stores the received data in a structured data store. The server associates each received input with user attribute information, such as language preference, preferred voice type, and device type, and also associates the input with past dialogue history information. The server holds the past dialogue history information in a data structure such as a sequence of interaction records, each record including a user utterance, a system response, a timestamp, and emotional state information.

The server converts the acoustic signal into a character string using a speech recognition algorithm. The server may use commercial speech recognition software or an API provided by a cloud-based speech recognition service as an example implementation, but the invention is not limited thereto. The speech recognition algorithm uses an acoustic model and a language model to map sequences of acoustic feature vectors, such as Mel-frequency cepstral coefficients, to symbol sequences representing characters. The server obtains the character string and associates it with the interaction record in memory.

The server performs emotion analysis processing on the voice information or the character information. The server may extract acoustic features, such as pitch, energy, speaking rate, and spectral features, from the acoustic signal, and the server may also analyze lexical and syntactic features from the character string. The server inputs these features to an emotion classifier implemented as a neural network or another machine learning model. In one embodiment, the emotion classifier is a multi-layer neural network that receives a concatenated vector of acoustic features and text embedding vectors and outputs probability scores over emotion categories such as joy, sadness, and stress. The server computes an emotional state information vector from these probability scores and stores it within the interaction record.

The server constructs a prompt sentence for a generative AI model based on the user information and the past dialogue history information. The server generates the prompt sentence as a natural language instruction string that encodes at least: the latest user character string, a summary of past dialogue turns, user attribute information, and emotional state information. The server uses a non-trivial template mechanism that programmatically selects which past turns to include, how to compress them, and how to represent the emotional state in text form. By doing so, the server provides the generative AI model with a well-structured context that reduces ambiguity and improves generation consistency.

The server, for example, constructs a prompt sentence such as:
“The user said in Japanese: ‘Let me know today's news’
The user prefers a friendly and calm speaking style.
The recent dialog history is: the user has asked for news updates every morning.
Please summarize the most important world and domestic news from today in Japanese, in about 5 short sentences. Use simple and friendly language suitable for listening.”

In another example, the server constructs a prompt sentence such as:
“The user said in Japanese: ‘Recently, I have not talked with nobody’
The emotion analysis result indicates that the user feels lonely and sad.
You are a kind and empathetic counselor.
Please generate a short, comforting message in Japanese, no more than 4 sentences.”

In another example, the server constructs a prompt sentence such as:
“The user said in Japanese: ‘Today, I was so tired with the work’
The emotion analysis result is: stress=high, fatigue=high.
Please generate a supportive and encouraging response in Japanese and include 2 or 3 simple relaxation tips that can be done at home.”

In another example, the server constructs a prompt sentence such as:
“The user is currently in a joyful mood according to the emotion analysis.
The user likes the character [character name].
Please generate a fun and light-hearted short story in Japanese featuring this character, in about 150 words.”

The server thereby uses an explicit prompt sentence generation procedure that systematically encodes multi-turn context, user attributes, and emotional state into a single string. This procedure is different from simply passing the last user utterance to a model and results in significant technical effects, including improved context tracking and reduced need for additional network calls due to misunderstandings.

The server inputs the prompt sentence into a generative AI model operating on one or more accelerator devices such as graphics processing units. In one embodiment, the generative AI model is a transformer-based language model pre-trained on large-scale text corpora and fine-tuned on dialog or counseling data. The server provides the prompt sentence as a sequence of tokens, where each token is embedded into a vector representation using an embedding matrix stored in memory. The generative AI model processes the token sequence through multiple layers of self-attention and feed-forward networks. Each attention layer computes attention weights between all token positions and performs weighted sums of value vectors, and the feed-forward network applies non-linear transformations to each position.

The server configures the generative AI model with parameters such as the maximum output length, a temperature parameter controlling randomness, and a top-k or top-p sampling strategy determining which tokens are considered during generation. The server performs auto-regressive generation, where the model iteratively predicts the next token based on the previous tokens and the prompt sentence. The server monitors the output for termination conditions such as a stop symbol or maximum length.

The server obtains a response character string by decoding the generated token sequence into characters using a character encoding. The server then associates the response character string with the interaction record and may compute additional features such as length, estimated difficulty level, or topic category using auxiliary classifiers.

The server modifies or confirms the emotional state information used for acoustic rendering.

The server may infer from the response character string whether the content is intended to be comforting, informative, or humorous using another classifier or rule-based mapping. The server integrates this derived information with the previously computed emotional state information of the user. The server determines voice characteristic designation information such as speaking rate, prosody parameters, and sound volume. For example, when the emotional state information indicates sadness, the server sets a slower speaking rate, a narrower pitch range, and a lower average volume. When the emotional state information indicates joy, the server sets a faster speaking rate, a more dynamic prosody, and a slightly higher volume.

The server inputs the response character string and the voice characteristic designation information into a speech synthesis processing algorithm or a voice conversion processing algorithm. In one embodiment, the speech synthesis processing algorithm is a neural text-to-speech model that consists of a sequence-to-sequence text encoder and a neural vocoder. The text encoder converts the response character string into a sequence of phoneme representations and prosodic features. The vocoder converts the prosodic representations into an acoustic signal by generating a waveform sample-by-sample or frame-by-frame. The server passes the speaking rate and prosody parameters into the encoder and vocoder to modify the timing and pitch contours during synthesis.

In another embodiment, the server employs a voice conversion processing algorithm that receives a neutral synthesized speech signal and converts it to a speech signal that imitates a target speaker characteristic. The voice conversion algorithm may use a latent representation of speaker identity and apply a transformation of the spectral envelope to produce an acoustic signal with the desired timbre. The server provides the speaker identity code, which may represent a generic voice type, and the emotional state-related parameters to the voice conversion algorithm.

The server thereby generates an acoustic signal representing the response in a voice that reflects both the chosen speaker characteristic and the emotional characteristic. The server then transmits the acoustic signal to the terminal over the network. The server may stream the acoustic signal using chunked transfer encoding, or the server may transmit a complete file in a container format that the terminal can decode.

The terminal receives the acoustic signal and buffers the data in a playback module. The terminal decodes the audio format, converts the digital samples into analog signals through a digital-to-analog converter, and drives the loudspeaker or earphones. The terminal may simultaneously display the response character string or a shortened text version on its display, so that the user can both listen and read.

The user listens to the acoustic output and perceives that the content, tone, and speaking style are adapted to the user's emotional state and preferences. The user may then provide another utterance, and the above-described server-side processing repeats, with past dialogue history information and emotional state information being continuously updated and utilized.

The server thereby improves computer technology in several ways. First, the server reduces the number of failed or irrelevant responses by using a structured prompt sentence that encodes context, which leads to fewer correction requests and reduced network traffic.

Second, the server reduces latency by storing and reusing past dialogue history information in a compact representation, avoiding repeated recomputation of context. Third, the server improves the efficiency of speech synthesis by mapping emotional state information directly to acoustic parameters in a controlled and automated manner, which removes the need for repeated trial-and-error synthesis. Fourth, the server increases the accuracy and stability of response generation by using emotion-aware prompt construction, which guides the generative AI model to generate content that is semantically consistent with user needs. The server is not merely automating a human counselor's behavior. Rather, the server is implementing non-conventional data flow and control logic between the emotion analysis module, the prompt sentence construction module, the generative AI model, and the speech synthesis module. The server uses internal representations such as token embeddings, attention weights, emotion vectors, and prosody parameters that do not exist in human cognition in the same structured way. The server applies objective criteria and numerical thresholds to determine which pieces of dialogue history to include in a prompt, how to compress them, and how to adjust the acoustic parameters.

In one embodiment, the server uses a specific training procedure for the generative AI model and the emotion classifier. The server trains the generative AI model on a corpus of dialog pairs annotated with emotional labels. The server defines a loss function that combines a language modeling loss with an auxiliary loss measuring the alignment between generated responses and target emotion labels. The server updates the model weights using stochastic gradient descent with backpropagation. The server may apply data augmentation techniques, such as back-translation or paraphrasing, to enlarge the training corpus and improve robustness. The server trains the emotion classifier on multimodal data by defining a cross-entropy loss over emotion categories and optimizing the classifier weights in a similar manner.

In another embodiment, the server uses a specialized data structure to manage past dialogue history information. The server maintains a sliding window of recent turns and an index of key topics and emotion transitions. The server stores topic and emotion summaries in a compressed vector representation. When constructing a prompt sentence, the server retrieves only the most relevant parts of the history based on similarity scores computed between the current user input vector and the stored topic vectors. This approach reduces the size of the prompt and shortens the sequence length processed by the generative AI model, thereby reducing computation time and memory usage on the server and improving processing speed.

In another embodiment, the server includes a rule-based layer that modifies the generative AI output in special circumstances. For example, when detected emotion exceeds a threshold for stress, the server enforces that the prompt sentence must request at least one concrete relaxation instruction. This rule is applied algorithmically and is not a human heuristic performed manually. The combination of generative AI model behavior and rule-based modifications yields a hybrid system in which the generative AI model operates under explicit machine-enforced constraints.

The server, terminal, and user therefore cooperate in a computer-implemented communication system that is tightly integrated at the technical level. The server not only processes data but also controls the generation of acoustic signals with precise timing and prosody via specific parameters derived from emotion analysis and prompt sentence design.

The server thereby improves the functioning of the underlying computing system, as evidenced by efficient resource utilization, improved output quality, and reduced error rates, rather than merely providing an abstract business method or mental process.

Multiple variations of the described embodiment are possible. The server may use a different neural network architecture, such as a recurrent neural network or a convolutional sequence model, in place of or in combination with the transformer-based model. The server may implement the emotion analysis function using a graphical model or a support vector machine instead of a neural network. The speech synthesis function may be implemented using a concatenative engine with a database of recorded units. The terminal may be a vehicle-mounted device or a home appliance. In any such variant, the essential configuration remains that the server constructs an emotion-aware, context-aware prompt sentence, uses a generative AI model to generate a response character string, converts the response character string into an acoustic signal with controlled voice characteristics, and transmits the acoustic signal to the terminal for presentation to the user.

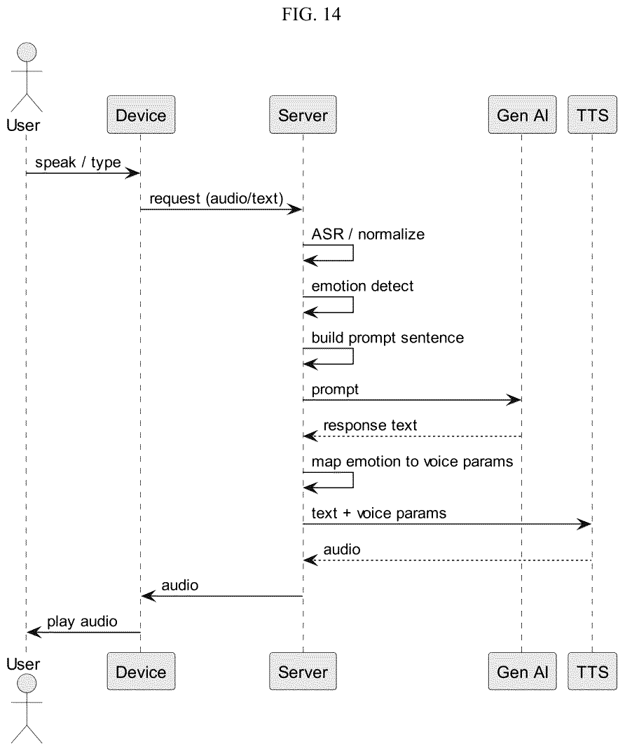

The following describes the processing flow using FIG. 14.

### Step 1:

User provides input to the terminal.

User speaks a request such as “Tell me today's news” or “I feel lonely today,” or types a text message into a user interface on the terminal.

Input: Natural speech sound or typed text from the user.

Output: Analog audio signal at the microphone, or character string in the terminal's input field.

### Step 2:

Terminal digitizes and packages the user input.

Terminal converts the analog audio signal from the microphone into a digital acoustic signal (for example, 16-bit PCM at 16 kHz), performs basic preprocessing such as noise reduction and level normalization, and encodes the signal (for example, as PCM or a compressed codec). Terminal collects user attribute information such as language setting, preferred voice type, and device type, and combines this with the audio or text into a request message.

Input: Analog audio from the user and device settings, or typed text and device settings.

Output: Structured request data including digital audio or text, user attribute information, and a session identifier.

### Step 3:

Terminal transmits the request to the server.

Terminal sends the structured request data to the server over a network connection using a protocol such as HTTPS, targeting a predefined application endpoint. Terminal may also include a short history of recent exchanges as metadata to support context.

Input: Structured request data stored in the terminal.

Output: Network packet stream carrying the request data to the server.

### Step 4:

Server receives and stores the raw input.

Server accepts the HTTP request, parses headers and body, and extracts the digital audio or character string, the user attribute information, and session information. Server assigns or retrieves an interaction identifier and stores these elements in a persistent or in-memory data structure representing the current dialogue state.

Input: Network packet stream from the terminal.

Output: Internal interaction record containing raw input data, user attributes, and session identifiers.

### Step 5:

Server normalizes audio data and performs speech recognition when necessary.

Server checks whether the interaction record contains audio; if so, server converts the audio format to a standard internal format using an audio processing library, for example resampling to a fixed sampling rate and converting to mono. Server extracts acoustic features such as Mel-frequency cepstral coefficients or log-mel spectrogram frames from the normalized audio and sends these frames to a speech recognition engine. The speech recognition engine decodes the feature sequence into a character string using an acoustic model and a language model.

Input: Digital audio data from the interaction record.

Output: Character string transcribed from the user's speech, with optional confidence scores.

### Step 6:

Server selects or validates the user text for downstream processing.

Server determines whether the current interaction provides text from speech recognition or directly from the terminal. Server selects the most reliable character string, optionally applying a confidence threshold to ignore low-confidence recognition segments. Server stores the selected character string as the current user utterance in the interaction record.

Input: Transcribed character string from speech recognition and/or raw text from the terminal.

Output: Canonical user utterance text stored in the interaction record.

### Step 7:

Server performs emotion analysis on the user input.

Server extracts textual features from the canonical user utterance, such as token embeddings, sentiment indicators, or part-of-speech tags. Server optionally reuses acoustic features extracted in the speech recognition stage. Server inputs these combined features into an emotion classifier implemented as a neural network or other machine learning model, and computes emotional state information such as probabilities for sadness, joy, stress, or calmness.

Input: Canonical user utterance text and optional acoustic features.

Output: Emotional state information vector or label stored in the interaction record.

### Step 8:

Server updates and compresses past dialogue history information.

Server retrieves prior interaction records associated with the same session identifier and selects a subset of recent turns according to rules such as recency thresholds or topic relevance. Server may compute topic embeddings for each turn and select those with highest similarity to the current utterance. Server compresses the selected turns into a text summary or a reduced sequence of user-system pairs to be used in a prompt sentence.

Input: Collection of past interaction records for the session and the current user utterance.

Output: Compressed dialogue history text and associated metadata stored with the current interaction.

### Step 9:

Server constructs a prompt sentence for the generative AI model.

Server combines the current user utterance, the compressed dialogue history, the user attribute information, and the emotional state information into a single structured instruction string. Server applies a template or rule set to determine the order and phrasing of these components, thereby generating a prompt sentence that explicitly specifies the task, the context, the desired style, and any emotional constraints.

Input: Canonical user utterance, compressed dialogue history text, user attribute information, and emotional state information.

Output: Prompt sentence string stored in the interaction record and ready for input to the generative AI model.

### Step 10:

Server tokenizes the prompt sentence and prepares input for the generative AI model.

Server converts the prompt sentence into a sequence of tokens using a predefined tokenizer associated with the generative AI model. Server maps each token to a numeric index and then to a vector representation via an embedding matrix. Server creates a model input structure containing the token indices or embeddings and generation parameters such as maximum length, temperature, and sampling strategy.

Input: Prompt sentence string.

Output: Token sequence and model input structure suitable for the generative AI model.

### Step 11:

Server performs response generation using the generative AI model.

Server forwards the token sequence and generation parameters to a generative AI model implemented as a transformer-based neural network running on one or more accelerator devices. The model processes the sequence through stacked self-attention and feed-forward layers, incrementally predicting next tokens based on prior tokens. Server repeatedly feeds back predicted tokens until a termination condition is reached.

Input: Token sequence representing the prompt sentence and generation parameters.

Output: Generated token sequence representing the model's response.

### Step 12:

Server decodes the generated tokens into a response character string.

Server converts the generated token indices into characters using a vocabulary mapping and joins them into a response character string. Server optionally removes control symbols, trims unwanted prefixes or suffixes, and applies simple post-processing such as normalization of whitespace or punctuation. Server stores the finalized response character string in the interaction record.

Input: Generated token sequence from the generative AI model.

Output: Clean response character string suitable for further processing.

### Step 13:

Server derives or refines acoustic control parameters from emotion and content.

Server uses the emotional state information from the user side and may analyze the response character string to derive additional cues, such as whether the content is advisory, informative, or humorous. Server maps these cues to voice characteristic designation information, specifying values such as target speaker identity, speaking rate, prosody pattern, and sound volume. For example, server may set a slower speaking rate and narrower pitch range for a sad emotional state, or a faster speaking rate and wider pitch range for a joyful state.

Input: Emotional state information and response character string.

Output: Voice characteristic designation information stored with the interaction record.

### Step 14:

Server prepares text and control data for speech synthesis or voice conversion.

Server converts the response character string into a phoneme or grapheme sequence using a text-processing module, and attaches timing and emphasis markers derived from punctuation and prosody rules. Server creates an input structure for the synthesis engine that includes the phoneme sequence, prosodic hints, and the voice characteristic designation information.

Input: Response character string and voice characteristic designation information.

Output: Synthesis engine input structure containing phonetic and prosodic data and voice control parameters.

### Step 15:

Server generates an acoustic signal using a speech synthesis or voice conversion algorithm.

Server passes the synthesis engine input structure to a speech synthesis processing algorithm or voice conversion processing algorithm. The algorithm computes intermediate representations such as mel-spectrograms and then generates a waveform using a neural vocoder or another waveform generation method. Server applies the speaking rate, prosody, and volume parameters during this computation to shape the timing and amplitude of the output signal.

Input: Synthesis engine input structure.

Output: Acoustic signal representing the response in the designated voice and style.

### Step 16:

Server packages and transmits the acoustic signal to the terminal.

Server encodes the acoustic signal into an agreed audio format, such as a waveform file or a streaming bitstream, and constructs a response message that may also contain the response character string and metadata such as duration. Server sends this message to the terminal via the established network connection, optionally using streaming to reduce playback latency.

Input: Acoustic signal and associated metadata.

Output: Network packet stream carrying audio data and optional metadata to the terminal.

### Step 17:

Terminal receives, decodes, and plays back the acoustic signal.

Terminal receives the network packet stream, decodes the audio data into digital samples, and buffers them in an audio playback component. Terminal configures its audio output path, such as selecting a loudspeaker or earphones, and sequentially outputs the samples to a digital-to-analog converter. Terminal may also display the text of the response on the screen as a visual aid.

Input: Encoded acoustic signal and optional response text from the server.

Output: Audible sound produced by the terminal's acoustic output unit and optionally displayed text on the screen.

### Step 18:

User perceives the response and optionally initiates a subsequent interaction.

User listens to the spoken response and may read the displayed text. User perceives that the voice, tone, and content are adapted to the user's emotional state and preferences. User may then decide to ask a follow-up question or provide additional comments, starting a new iteration of the described processing flow.

Input: Acoustic and visual output from the terminal.

Output: New speech or text input for a subsequent interaction, returning control to earlier steps.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

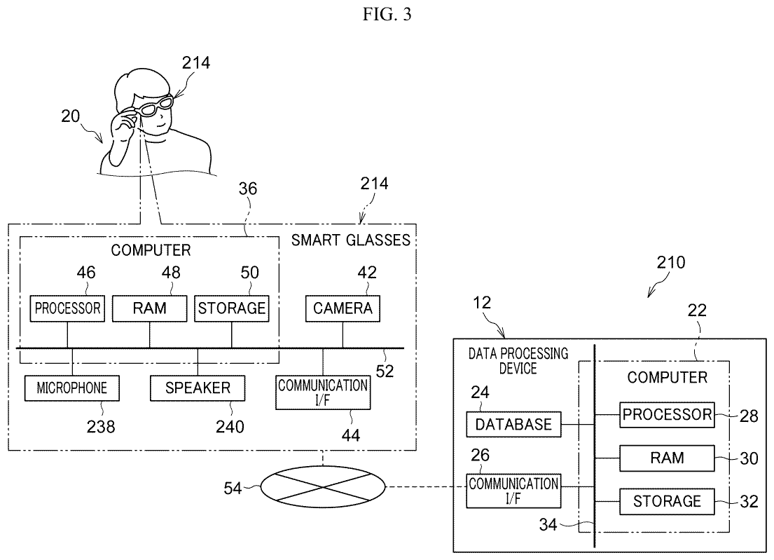

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

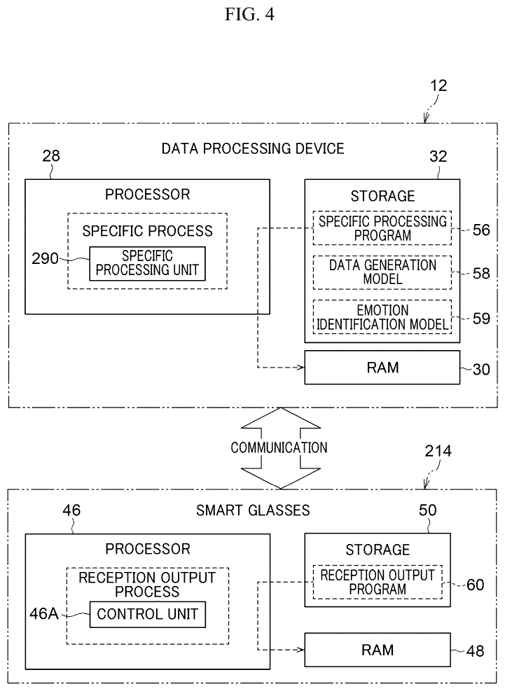

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

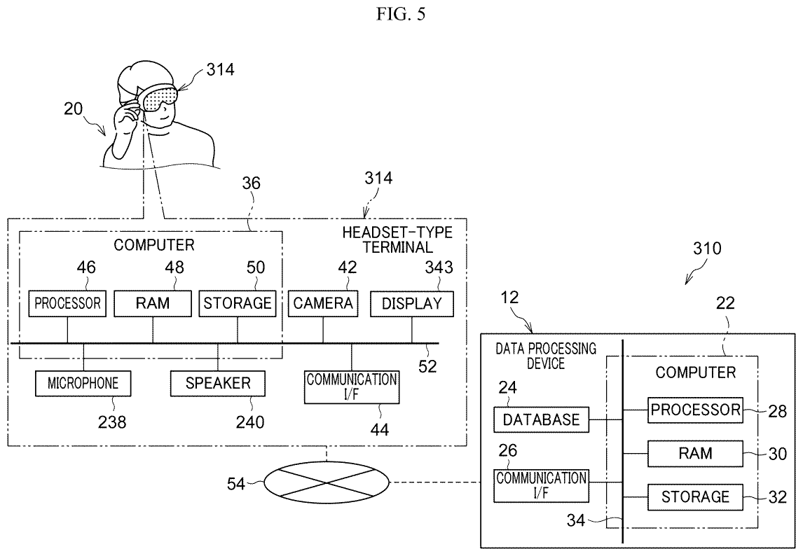

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

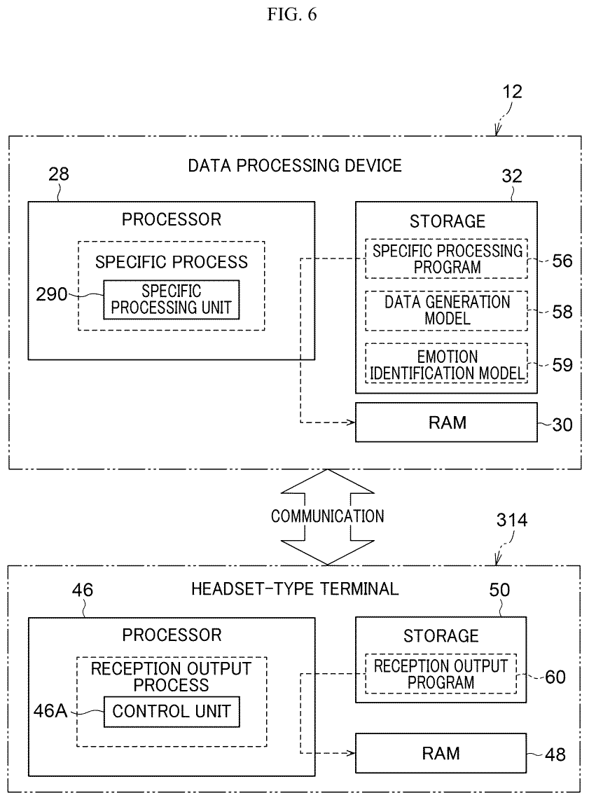

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

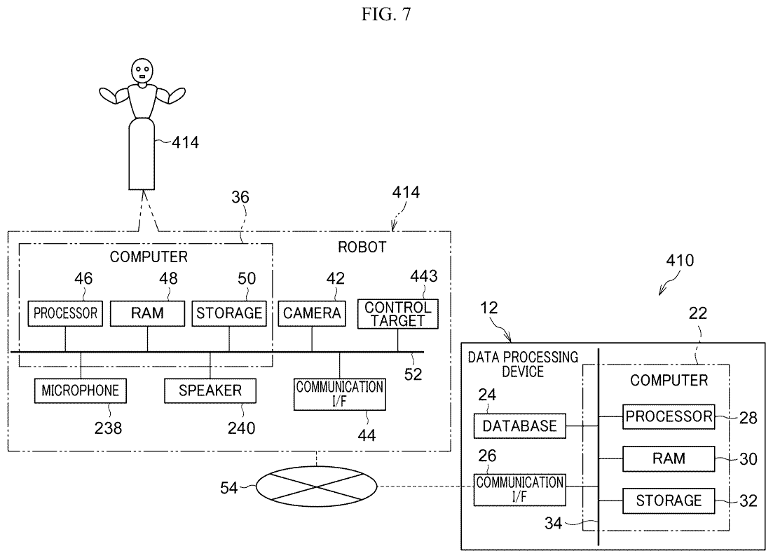

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

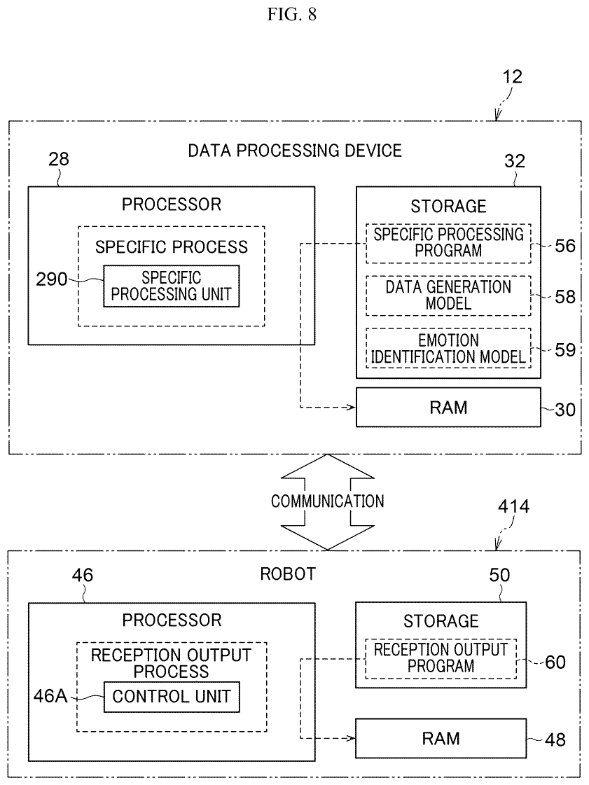

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

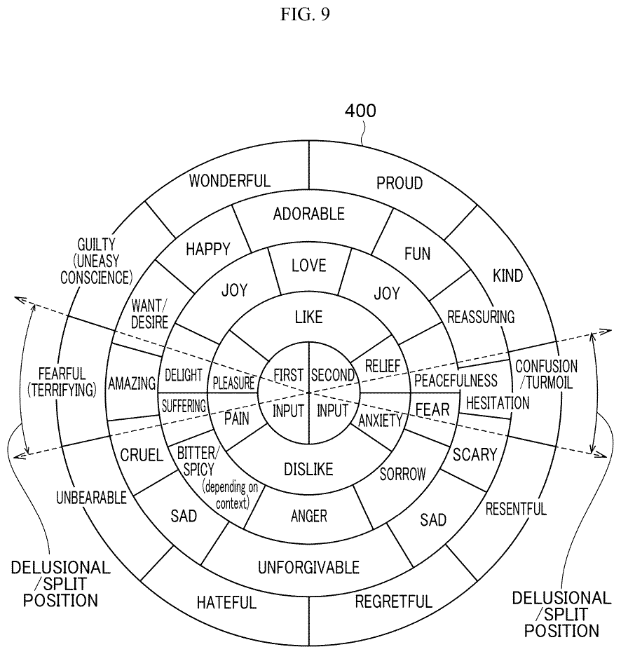

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

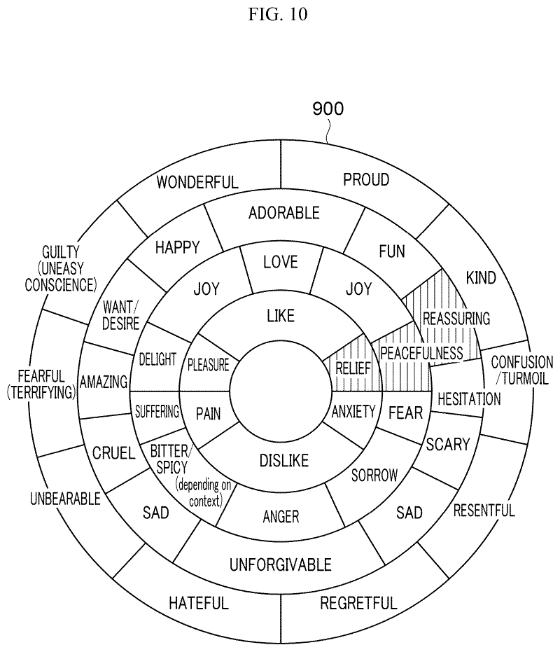

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive character information from a user through a user-side apparatus,
generate structured information including the character information and user identification information and receive the structured information from the user-side apparatus via a communication interface,
extract the character information from the structured information and construct a prompt sentence to be input to a generative information processing model, the prompt sentence being constructed on the basis of the character information and conversation history information stored in a storage medium,
input the prompt sentence to the generative information processing model to cause the generative information processing model to generate a response character string,
perform content checking and format adjustment on the response character string to generate a text string for speech synthesis processing,
associate the text string for speech synthesis processing with a voice identifier selected by the user and generate a speech generation request including the text string for speech synthesis processing and the voice identifier for transmission to a voice conversion processing apparatus,
cause the voice conversion processing apparatus to input the text string for speech synthesis processing to a speech synthesis algorithm and to generate audio data as a speech signal based on speaker feature information corresponding to the voice identifier,
convert the audio data into a communication format suitable for transmission to the user-side apparatus and transmit the converted audio data to the user-side apparatus, and
cause the user-side apparatus to decode the received audio data and reproduce the decoded audio data through an acoustic output apparatus.

### (Supplementary 2)

The system according to supplementary 1,
wherein the processor is configured to
acquire past conversation history information of the user from a storage medium, and modify context information and instruction conditions included in the prompt sentence on the basis of the past conversation history information so as to adjust the prompt sentence to instruct the generative information processing model to generate a personalized response for the user.

### (Supplementary 3)

The system according to supplementary 1,
wherein the processor is configured to
execute emotion analysis processing on input character information from the user to estimate an emotional state of the user, and add instruction information indicating a response style and an expression policy corresponding to the emotional state to the prompt sentence so as to instruct the generative information processing model to generate a response corresponding to the emotional state, and output the generated response as the audio data.

### Application Example 1

### (Supplementary 1)

A system comprising a processor,
wherein the processor is configured to
receive, from a terminal, audio information corresponding to voice input of a user and convert the audio information into character information by using a speech recognition unit, construct a prompt sentence on the basis of the character information and voice type information selected by the user on the terminal, input the prompt sentence into a generative AI model as a generative information processing apparatus, and cause the generative AI model to generate response character information,
convert the response character information into an audio signal having speaker characteristics corresponding to the voice type information by using a speech synthesis unit, and
transmit the audio signal to the terminal and control output of the audio signal to the user via an output device of the terminal.

### (Supplementary 2)

The system according to supplementary 1,
wherein the processor is configured to
acquire past interaction history information of the user and the voice type information from a storage device, adjust content of the prompt sentence on the basis of the past interaction history information and the voice type information, and cause the generative AI model to generate personalized response character information.

### (Supplementary 3)

The system according to supplementary 1,
wherein the processor is configured to
cooperate with an emotion analysis unit that estimates emotion state information from the character information, add instruction information indicating an emotion-dependent response policy to the prompt sentence on the basis of the emotion state information, and cause the generative AI model to generate response character information corresponding to the emotion state information.

### Example 2

### (Supplementary 1)

A system comprising a processor,
wherein the processor is configured to
acquire information from a user and receive the information from a terminal,
analyze a request content of the user based on the information, and generate a prompt sentence including the request content and an instruction content of the system, the processor being further configured to input the prompt sentence into a generative AI model so as to cause the generative AI model to generate a text response,
manage voice characteristic information acquired from the user and, based on the voice characteristic information, select at least one of a speaker attribute, a speaking rate, a pitch, and a speaking style for a speech synthesis process,
input the text response into the selected speech synthesis process and generate an audio signal reflecting the voice characteristic information, and
transmit the audio signal to the terminal and cause the terminal to output the audio signal as audio data reproducible on the terminal.

### (Supplementary 2)

The system according to supplementary 1,
wherein the processor is configured to refer to past interaction history data stored in association with identification information of the user, and adjust a content or an output condition of the prompt sentence based on the past interaction history data so as to cause the generative AI model to generate a personalized response.

### (Supplementary 3)

The system according to supplementary 1,
wherein the processor is configured to estimate an emotional state from input data of the user, add or reflect information indicating the emotional state to or in the prompt sentence so as to cause the generative AI model to generate a response corresponding to the emotional state, and generate the audio signal by using a voice quality or a speaking style corresponding to the emotional state in the speech synthesis process.

### Application Example 2

### (Supplementary 1)

A system comprising a processor,
wherein the processor is configured to
receive voice information or character information from a user, convert the voice information from an acoustic signal into a character string, and generate user information including the character string and user attribute information; and
construct a prompt sentence for causing a generative information processing model to generate a response sentence, based on the user information and past dialogue history information, input the prompt sentence into the generative information processing model, and acquire a response character string; and
input the response character string into a speech synthesis processing algorithm or a voice conversion processing algorithm, based on the response character string and voice characteristic designation information, and generate an acoustic signal having a predetermined speaker characteristic or emotional characteristic; and
transmit the acoustic signal to a terminal device and cause the acoustic signal to be presented to the user via an acoustic output unit of the terminal device.

### (Supplementary 2)

The system according to supplementary 1,
wherein the processor is configured to
dynamically modify the prompt sentence so as to cause the generative information processing model to generate a personalized response character string, by adjusting a style, content, and length of the prompt sentence based on the past dialogue history information of the user and emotional state information associated with the response character string.

### (Supplementary 3)

The system according to supplementary 1,
wherein the processor is configured to
perform emotion analysis processing on the voice information or the character information acquired from the user to extract emotional state information, include the emotional state information in the prompt sentence to be input to the generative information processing model so as to cause the generative information processing model to generate a response character string having content and tone according to the emotional state information, and generate the acoustic signal by including, as the voice characteristic designation information, at least one of speaking rate, prosody, and sound volume corresponding to the emotional state information.

What is claimed is:

1. A system comprising:
a communication interface connected to a packet-switched network;
a storage medium; and
circuitry configured to:
receive, via the communication interface and the packet-switched network, input data from a terminal device;
retrieve, from the storage medium, interaction history data associated with the input data;
construct a prompt sequence based on the input data and the interaction history data;
input the prompt sequence to a generative neural network model to cause the generative neural network model to generate a response data sequence;
perform content verification and format adjustment on the response data sequence to produce a processed text sequence;
input the processed text sequence and speaker parameter data into a speech synthesis model to generate an audio data signal; and
transmit, via the communication interface and the packet-switched network, the audio data signal to the terminal device.

2. The system according to claim 1, wherein the circuitry is further configured to execute a classification neural network on at least a portion of the input data to compute an emotional state vector, and to incorporate instruction data derived from the emotional state vector into the prompt sequence.

3. The system according to claim 2, wherein the classification neural network maps the at least a portion of the input data to coordinates on a multidimensional emotion map in which a plurality of emotional categories are arranged according to a valence dimension and an arousal dimension, and wherein the emotional state vector comprises the coordinates on the multidimensional emotion map.

4. The system according to claim 3, wherein the instruction data derived from the emotional state vector specifies an emotion-dependent response policy that controls at least one of a tone, a formality level, and a maximum length of the response data sequence generated by the generative neural network model.

5. The system according to claim 4, wherein the circuitry is further configured to adjust at least one of a speaking rate parameter, a prosody contour parameter, and a sound volume parameter of the speech synthesis model based on the emotional state vector, such that the audio data signal reflects an acoustic characteristic corresponding to the emotional state vector.

6. The system according to claim 1, wherein the circuitry is further configured to retrieve, from the storage medium, user preference data associated with the input data, and to modify context information and instruction conditions included in the prompt sequence based on the interaction history data and the user preference data so as to cause the generative neural network model to generate a personalized response data sequence.

7. The system according to claim 6, wherein the speaker parameter data comprises a voice identifier selected via the terminal device, and wherein the circuitry is further configured to retrieve, from the storage medium, a speaker embedding vector corresponding to the voice identifier and to supply the speaker embedding vector to the speech synthesis model.

8. The system according to claim 7, wherein the circuitry is further configured to compute a vector representation for each of a plurality of previous interaction turns in the interaction history data, to compute a similarity score between the vector representation of each previous interaction turn and a vector representation of the input data, and to select a subset of the plurality of previous interaction turns having similarity scores exceeding a threshold for inclusion in the prompt sequence.

9. The system according to claim 1, wherein the input data comprises an audio input signal, and wherein the circuitry is further configured to convert the audio input signal into character information by using a speech recognition model before constructing the prompt sequence.

10. The system according to claim 9, wherein the circuitry is further configured to extract acoustic features from the audio input signal and lexical features from the character information, and to input the acoustic features and the lexical features into an emotion classification model to compute emotion state information.

11. The system according to claim 10, wherein the acoustic features comprise mel-frequency cepstral coefficients or log-mel spectrogram frames extracted from overlapping windows of the audio input signal.

12. The system according to claim 1, wherein the generative neural network model comprises a transformer architecture having a plurality of self-attention layers and feed-forward sub-layers, and wherein the circuitry is further configured to convert the prompt sequence into a token sequence using a tokenizer and to execute a decoding algorithm on output probability distributions produced by the transformer architecture to generate the response data sequence.

13. The system according to claim 12, wherein the decoding algorithm comprises at least one of greedy decoding, beam search, and nucleus sampling with a temperature parameter, and wherein the circuitry is further configured to enforce a maximum output token count and a stop condition on the decoding algorithm.

14. The system according to claim 1, wherein the speech synthesis model comprises a text preprocessing front-end that converts the processed text sequence into a phoneme sequence, an acoustic model that converts the phoneme sequence and the speaker parameter data into an acoustic feature sequence, and a vocoder model that converts the acoustic feature sequence into waveform samples constituting the audio data signal.

15. The system according to claim 14, wherein the acoustic feature sequence comprises mel-spectrogram frames, and wherein the vocoder model comprises a neural network vocoder.

16. The system according to claim 1, wherein performing the content verification comprises applying pattern matching and rule-based filters to the response data sequence to detect prohibited expressions, and wherein performing the format adjustment comprises normalizing whitespace and ensuring sentence termination punctuation in the response data sequence.

17. The system according to claim 16, wherein, in response to the content verification detecting a prohibited expression, the circuitry is further configured to modify the prompt sequence and to cause the generative neural network model to regenerate the response data sequence.

18. A system comprising:
a communication interface connected to a packet-switched network;
a storage medium storing interaction history data and speaker parameter data; and
circuitry configured to:
receive, via the communication interface and the packet-switched network, input data and user identification information from a terminal device;
retrieve, from the storage medium, the interaction history data associated with the user identification information;
execute a classification model on at least a portion of the input data to compute emotion state information;
construct a prompt sequence based on the input data, the interaction history data, and instruction data derived from the emotion state information;
input the prompt sequence to a generative neural network model to cause the generative neural network model to generate a response data sequence;
perform content verification and format adjustment on the response data sequence to produce a processed text sequence;
retrieve, from the storage medium, the speaker parameter data corresponding to a voice identifier associated with the user identification information;
input the processed text sequence and the speaker parameter data into a speech synthesis model to generate an audio data signal; and
transmit, via the communication interface and the packet-switched network, the audio data signal to the terminal device.

19. The system according to claim 18, wherein the circuitry is further configured to adjust at least one of a speaking rate, a prosody contour, and a sound volume of the speech synthesis model based on the emotion state information, and to store the response data sequence and the emotion state information as updated interaction history data in the storage medium.

20. A method performed by circuitry, the method comprising:
receiving, via a communication interface connected to a packet-switched network, input data from a terminal device;
retrieving, from a storage medium, interaction history data associated with the input data;
constructing a prompt sequence based on the input data and the interaction history data;
inputting the prompt sequence to a generative neural network model to cause the generative neural network model to generate a response data sequence;
performing content verification and format adjustment on the response data sequence to produce a processed text sequence;
inputting the processed text sequence and speaker parameter data into a speech synthesis model to generate an audio data signal; and
transmitting, via the communication interface and the packet-switched network, the audio data signal to the terminal device.
